(19) United States
(12) Patent Application Publication
(10) Pub. No.: US 2024/0304215 A1
(43) Pub. Date: Sep. 12, 2024

(54) MAGNETIC RECORDING MEDIUM, MAGNETIC TAPE CARTRIDGE, AND MAGNETIC RECORDING AND REPRODUCING DEVICE

(71) Applicant: FUJIFILM Corporation, Tokyo (JP)

(72) Inventor: Masahide SATO, Minamiashigara-shi (JP)

(73) Assignee: FUJIFILM Corporation, Tokyo (JP)

(21) Appl. No.: 18/585,700

(22) Filed: Feb. 23, 2024

(30) Foreign Application Priority Data
Feb. 27, 2023 (JP) 2023-028748
Feb. 15, 2024 (JP) 2024-020859

(51) Int. Cl. G11B 5/725; G11B 5/84

(52) U.S. Cl. CPC G11B 5/7253; G11B 5/84

(57) ABSTRACT

There is provided a magnetic recording medium in which a contact angle with water, which is measured on a surface of the magnetic layer, is 96 degrees or more, a fluorine concentration F obtained by X-ray photoelectron spectroscopy performed on the surface of the magnetic layer at a photoelectron take-off angle of 10 degrees is 1.0 at % or more and less than 5.0 at %, and ΔC calculated by Equation ΔC=C_{before}−C_{after} is 10.0 at % or more and 30.0 at % or less. The C_{before} is a C—H derived carbon concentration calculated from a C—H peak surface area ratio in C1s spectra obtained by the X-ray photoelectron spectroscopy performed on the surface of the magnetic layer at the photoelectron take-off angle of 10 degrees before a methanol extraction treatment, and the C_{after} is a C—H derived carbon concentration after the methanol extraction treatment.

### CROSS-REFERENCE TO RELATED APPLICATIONS

This application claims priority under 35 U.S.C 119 to Japanese Patent Application No. 2023-028748 filed on Feb. 27, 2023 and Japanese Patent Application No. 2024-020859 filed on Feb. 15, 2024. Each of the above applications is hereby expressly incorporated by reference, in its entirety, into the present application.

### BACKGROUND OF THE INVENTION

### 1. Field of the Invention

The present invention relates to a magnetic recording medium, a magnetic tape cartridge, and a magnetic recording and reproducing device.

### 2. Description of the Related Art

A magnetic recording medium has been widely used as a recording medium for recording various pieces of data (see, for example, JP2021-180060A).

### SUMMARY OF THE INVENTION

JP2021-180060A discloses a magnetic recording medium containing a carbon-based compound and a fluorine-based compound which can function as a lubricant (see, for example, Examples of JP2021-180060A). The lubricant can contribute to reducing a friction coefficient in a case where a magnetic layer surface of the magnetic recording medium and a magnetic head are slid on each other, that is, improving friction characteristics. Therefore, in order to further improve the friction characteristics of the magnetic recording medium, it is conceivable to increase an amount of the lubricant contained in the magnetic recording medium.

On the other hand, recording of data on the magnetic recording medium and reproducing of recorded data are generally performed by running the magnetic recording medium in a magnetic recording and reproducing device (generally referred to as a “drive”) and causing the magnetic layer surface and the magnetic head to come into contact with each other to be slid on each other. The presence of a foreign matter between the magnetic layer surface and the magnetic head during such running causes a deterioration in running stability. Examples of the foreign matter include scraps (referred to as “debris”) generated by scraping the magnetic recording medium due to sliding on the magnetic head. Therefore, it is desirable that the occurrence of debris can be suppressed in order to improve the running stability of the magnetic recording medium. However, the magnetic recording medium containing a larger amount of the lubricant tends to more easily generate debris. It is considered that this is because a large amount of the lubricant is contained, thereby decreasing strength of the magnetic recording medium (for example, the magnetic layer).

Under such circumstances, one aspect of the present invention is to provide a magnetic recording medium having excellent friction characteristics and generating less debris.

One aspect of the present invention is as follows.

[1] A magnetic recording medium comprising: a non-magnetic support; and a magnetic layer containing a ferromagnetic powder, in which a contact angle with water (hereinafter, also simply referred to as a “contact angle”), which is measured on a surface of the magnetic layer, is 96 degrees or more, a fluorine concentration F obtained by X-ray photoelectron spectroscopy performed on the surface of the magnetic layer at a photoelectron take-off angle of 10 degrees (hereinafter, also simply referred to as a “fluorine concentration F” or “F”) is 1.0 at % or more and less than 5.0 at %, and ΔC calculated by Equation ΔC=C_{before}−C_{after} is 10.0 at % or more and 30.0 at % or less, the C_{before} is a C—H derived carbon concentration calculated from a C—H peak surface area ratio in Cis spectra obtained by the X-ray photoelectron spectroscopy performed on the surface of the magnetic layer at the photoelectron take-off angle of 10 degrees before a methanol extraction treatment, and the C_{after} is a C—H derived carbon concentration calculated from the C—H peak surface area ratio in the Cis spectra obtained by the X-ray photoelectron spectroscopy performed on the surface of the magnetic layer at the photoelectron take-off angle of 10 degrees after the methanol extraction treatment.

[2] The magnetic recording medium according to [1], in which the contact angle is 96 degrees or more and 110 degrees or less.

[3] The magnetic recording medium according to [1] or [2], in which a vertical squareness ratio of the magnetic recording medium is 0.60 or more.

[4] The magnetic recording medium according to any one of [1] to [3], in which a vertical squareness ratio of the magnetic recording medium is 0.65 or more.

[5] The magnetic recording medium according to any one of [1] to [4], further comprising: a non-magnetic layer containing a non-magnetic powder between the non-magnetic support and the magnetic layer.

[6] The magnetic recording medium according to any one of [1] to [5], further comprising: a back coating layer containing a non-magnetic powder on a surface side of the non-magnetic support opposite to a surface side having the magnetic layer.

[7] The magnetic recording medium according to any one of [1] to [6], in which a total thickness of the magnetic recording medium is 5.2 μm or less.

[8] The magnetic recording medium according to any one of [1] to [7], in which a total thickness of the magnetic recording medium is 5.0 μm or less.

[9] The magnetic recording medium according to any one of [1] to [8], in which the non-magnetic support is a polyamide support.

[10] The magnetic recording medium according to any one of [1] to [9], in which the ferromagnetic powder is a hexagonal ferrite powder.

[11] The magnetic recording medium according to [10], in which the hexagonal ferrite powder is a hexagonal barium ferrite powder.

[12] The magnetic recording medium according to [10], in which the hexagonal ferrite powder is a hexagonal strontium ferrite powder.

[13] The magnetic recording medium according to any one of [1] to [9], in which the ferromagnetic powder is an ε-iron oxide powder.

[14] The magnetic recording medium according to any one of [1] to [13], in which the magnetic recording medium is a magnetic tape.

[15] The magnetic recording medium according to any one of [1] to [14], in which the contact angle is 96 degrees or more and 110 degrees or less, a vertical squareness ratio of the magnetic recording medium is 0.65 or more, a non-magnetic layer containing a non-magnetic powder is further provided between the non-magnetic support and the magnetic layer, a back coating layer containing a non-magnetic powder is further provided on a surface side of the non-magnetic support opposite to a surface side having the magnetic layer, a total thickness of the magnetic recording medium is 5.0 μm or less, the non-magnetic support is a polyamide support, the ferromagnetic powder is selected from the group consisting of a hexagonal barium ferrite powder, a hexagonal strontium ferrite powder, and an ε-iron oxide powder, and the magnetic recording medium is a magnetic tape.

[16] A magnetic tape cartridge comprising: the magnetic tape according to [14] or [15].

[17] A magnetic recording and reproducing device comprising: the magnetic recording medium according to any one of [1] to [15].

According to one aspect of the present invention, it is possible to provide a magnetic recording medium having excellent friction characteristics and generating less debris. In addition, according to one aspect of the present invention, it is possible to provide a magnetic tape cartridge and a magnetic recording and reproducing device including the magnetic recording medium.

### DESCRIPTION OF THE PREFERRED EMBODIMENTS

### Magnetic Recording Medium

One aspect of the present invention relates to a magnetic recording medium including a non-magnetic support, and a magnetic layer containing a ferromagnetic powder. A contact angle with water, which is measured on a surface of the magnetic layer, is 96 degrees or more, a fluorine concentration F obtained by X-ray photoelectron spectroscopy performed on the surface of the magnetic layer at a photoelectron take-off angle of 10 degrees is 1.0 at % or more and less than 5.0 at %, and ΔC calculated by Equation ΔC=C_{before}− C_{after} is 10.0 at % or more and 30.0 at % or less. The C_{before} is a C—H derived carbon concentration calculated from a C—H peak surface area ratio in Cis spectra obtained by the X-ray photoelectron spectroscopy performed on the surface of the magnetic layer at the photoelectron take-off angle of 10 degrees before a methanol extraction treatment, and the C_{after} is a C—H derived carbon concentration calculated from the C—H peak surface area ratio in the Cis spectra obtained by the X-ray photoelectron spectroscopy performed on the surface of the magnetic layer at the photoelectron take-off angle of 10 degrees after the methanol extraction treatment.

The present inventor supposes that the fluorine concentration F and the ΔC being in the above-described range contribute to suppression of occurrence of debris in the magnetic recording medium, and the contact angle of 96 degrees or more contributes to improvement of friction characteristics of the magnetic recording medium. Note that the present invention is not limited to the supposition described in the present specification.

Hereinafter, the magnetic recording medium will be further described in detail.

### Contact Angle

In the present invention and the present specification, the contact angle with water, which is measured on the surface of the magnetic layer of the magnetic recording medium, is a value measured by the following method. In the present invention and the present specification, the “magnetic layer surface (surface of the magnetic layer)” has the same meaning as a surface of the magnetic recording medium on a magnetic layer side.

The contact angle is measured by a liquid droplet method. Specifically, the contact angle is obtained by a θ/2 method by dropwise adding water onto a measurement point on the magnetic layer surface in a measurement environment of an atmosphere temperature of 25° C. and a relative humidity of 25%. An example of measurement conditions will be described below in the section of Examples. The measurement point is set to five points randomly selected on the magnetic layer surface, and the contact angle is measured at each of the five points. An arithmetic average of the five measured values thus obtained is defined as the contact angle with water, which is measured on the surface of the magnetic layer of the magnetic recording medium to be measured. A unit “degree” of the angle is also written as “°”.

From the viewpoint of improving the friction characteristics, the contact angle is 96 degrees or more, preferably 97 degrees or more, more preferably 98 degrees or more, still more preferably 99 degrees or more, and still more preferably 100 degrees or more. The contact angle may be, for example, 110 degrees or less, 108 degrees or less, 106 degrees or less, 104 degrees or less, 102 degrees or less, or 100 degrees or less. From the viewpoint of improving the friction characteristics of the magnetic recording medium, it is preferable that the value of the contact angle with water is large. Therefore, the contact angle with water, which is measured on the surface of the magnetic layer of the magnetic recording medium, may exceed the values exemplified here. It can be said that a magnetic layer surface having a large value of a contact angle with water has low surface free energy. In addition, it can be said that the magnetic layer surface having a large contact angle with water has a small influence of a meniscus (liquid crosslinking) formed by water in a sliding environment on the friction characteristics during sliding on a magnetic head. The present inventor considers that this point is particularly preferable for improving the friction characteristics of the magnetic recording medium in a high-humidity sliding environment (for example, a relative humidity of 60% or more and 100% or less). From the above point, the present inventor supposes that the contact angle with water of 96 degrees or more is the reason why the magnetic recording medium can exhibit excellent friction characteristics. A method of controlling the contact angle will be described below.

### Various Concentrations Obtained by X-Ray Photoelectron Spectroscopy Performed at Photoelectron Take-Off Angle of 10 Degrees

The term “fluorine concentration F” in the present invention and the present specification is a fluorine concentration obtained by X-ray photoelectron spectroscopy performed on the surface of the magnetic layer at a photoelectron take-off angle of 10 degrees.

The “C_{before}” in the present invention and the present specification is a C—H derived carbon concentration calculated from a C—H peak surface area ratio in CIs spectra obtained by the X-ray photoelectron spectroscopy performed on the surface of the magnetic layer at the photoelectron take-off angle of 10 degrees before a methanol extraction treatment.

The “C_{after}” in the present invention and the present specification is a C—H derived carbon concentration calculated from the C—H peak surface area ratio in the C1s spectra obtained by the X-ray photoelectron spectroscopy performed on the surface of the magnetic layer at the photoelectron take-off angle of 10 degrees after the methanol extraction treatment.

The term “X-ray photoelectron spectroscopy” refers to an analysis method generally also called electron spectroscopy for chemical analysis (ESCA) or X-ray photoelectron spectroscopy (XPS). In the following, X-ray photoelectron spectroscopy will also be referred to as ESCA. ESCA is an analysis method using a phenomenon of photoelectron emission in a case where a surface of a sample to be measured is irradiated with X-rays, and is widely used as an analysis method for a surface layer portion of the sample to be measured. According to ESCA, qualitative analysis and quantitative analysis can be performed using X-ray photoelectron spectroscopic spectra obtained by analysis on the surface of the sample to be measured. Generally, the following expression holds between a depth from the sample surface to the analysis position (hereinafter, also referred to as a “detection depth”) and a photoelectron take-off angle: detection depth ≈ average free path of electrons×3× sin θ. In the expression, the detection depth is a depth at which 95% of photoelectrons constituting X-ray photoelectron spectroscopic spectra are generated, and θ is a photoelectron take-off angle. From the expression described above, it can be seen that, as the photoelectron take-off angle decreases, the analysis regarding a shallow part of the depth from the sample surface can be performed, and as the photoelectron take-off angle increases, the analysis regarding a deep part of the depth can be performed. In the analysis performed by ESCA at a photoelectron take-off angle of 10 degrees, an extremely outermost surface layer portion extending from the sample surface to a depth of about several nm is usually an analysis position. Therefore, according to the analysis performed by ESCA on the surface of the magnetic layer of the magnetic recording medium at a photoelectron take-off angle of 10 degrees, it is possible to perform composition analysis regarding the extremely outermost surface layer portion extending from the surface of the magnetic layer to the depth of about several nm.

The fluorine concentration F is a proportion of fluorine atoms F to total (based on atom) 100 atom % of all elements detected by the qualitative analysis performed by ESCA. A region for the analysis is a region having an area of 300 μm×700 μm at a random position of the surface of the magnetic layer of the magnetic recording medium. The qualitative analysis is executed by wide scan measurement (pass energy: 160 eV, scan range: 0 to 1200 eV, energy resolution: 1 eV/step) performed by ESCA. Then, spectra of all the elements detected by the qualitative analysis are obtained by narrow scan measurement (pass energy: 80 eV, energy resolution: 0.1 eV, scan range: set for each element so that the entire spectra to be measured is included). An atomic concentration (unit: atom %) of each element with respect to all elements detected by the qualitative analysis is calculated from a peak surface area of each spectrum thus obtained. Here, a fluorine concentration is also calculated from a peak surface area of F1s spectra.

The C—H derived carbon concentration is a proportion of carbon atoms C constituting a C—H bond with respect to total (based on atom) 100 at % of all elements detected by the qualitative analysis performed by ESCA. The qualitative analysis is executed by wide scan measurement (pass energy: 160 eV, scan range: 0 to 1200 eV, energy resolution: 1 eV/step) performed by ESCA. Then, spectra of all the elements detected by the qualitative analysis are obtained by narrow scan measurement (pass energy: 80 eV, energy resolution: 0.1 eV, scan range: set for each element so that the entire spectra to be measured is included). An atomic concentration (unit: at %) of each element is calculated from the peak surface area of each spectrum thus obtained. Here, a carbon concentration is also calculated from a peak surface area of the C1s spectra.

In addition, the C1s spectra are acquired (pass energy: 10 eV, scan range: 276 to 296 eV, energy resolution: 0.1 eV/step). The acquired C₁s spectra are fitted by a nonlinear least-squares method using a Gauss-Lorentz complex function (Gaussian component: 70%, Lorentz component: 30%), a peak of a C—H bond in the C1s spectra is separated, and a proportion (peak area ratio) of the separated C—H peak in the C1s spectra is calculated. A C—H derived carbon concentration is calculated by multiplying the calculated C—H peak surface area ratio by the carbon concentration.

Two sample pieces are cut out from the magnetic recording medium to be measured. For one of the sample pieces, the above operation is performed three times at different positions on the magnetic layer surface without the methanol extraction treatment to obtain the fluorine concentration and the C—H derived carbon concentration. Respective arithmetic averages of the obtained values are defined as the fluorine concentration F and the C_{before} of the magnetic recording medium to be measured. A specific aspect of the above operation will be shown in the section of Examples described below.

A size of the sample piece to be subjected to the above operation without the methanol extraction treatment is not particularly limited. A size of the sample piece to be subjected to the methanol extraction treatment is set to a length of 5 cm for the magnetic tape. A width of the magnetic tape is usually ½ inches. 1 inch is 0.0254 meters. For the magnetic tape having a width other than ½ inches, as a sample piece to be subjected to the methanol extraction treatment, a sample piece having a length of 5 cm is cut out. For a magnetic disk, as a sample piece to be subjected to the methanol extraction treatment, a sample piece having the same size as that in the case of the magnetic tape need only be cut out.

For the other sample piece, the methanol extraction treatment is performed by the following method, and then the above operation is performed three times at different positions on the magnetic layer surface to obtain the C—H derived carbon concentration. An arithmetic average of the obtained values is defined as the C_{after} of the magnetic recording medium to be measured.

### Methanol Extraction Treatment:

The term “room temperature” described in the present specification is a temperature in a range of 20° C. to 25° C. The following treatment is performed at the room temperature. Regarding the following treatment, the term “about 30 mL” means a range of 25 to 35 mL.

A container containing fresh methanol is prepared. The term “fresh” means unused.

The entire sample piece is immersed in methanol (about 30 mL) in the container. For example, the entire sample piece having a width of ½ inches and a length of 5 cm is immersed in fresh methanol (about 30 mL) in a 100 mL beaker.

In a state where the entire sample piece is immersed in the methanol, the container is placed on a hot plate whose set temperature is set to 60° C. and heated for 3 hours.

After the heating, the sample piece is taken out from the methanol.

A container containing fresh normal hexane is prepared.

In order to clean the taken-out sample piece, the entire sample piece is allowed to stand for 30 minutes in a state of being immersed in normal hexane (about 30 mL) in the container. For example, the entire sample piece having a width of ½ inches and a length of 5 cm is allowed to stand for 30 minutes at the room temperature in a state of being immersed in fresh normal hexane (about 30 mL) in a 100 mL beaker.

After that, the sample piece is taken out from the normal hexane and dried at the room temperature for 1 day or more.

### Fluorine Concentration F

A fluorine-based compound can generally function as a lubricant. The present inventor considers that the fluorine concentration F obtained for the magnetic recording medium as described above can be an indicator of the presence amount of the fluorine-based compound in the extremely outermost surface layer portion of the magnetic layer. Then, the present inventor considers that the fluorine concentration F of less than 5.0 at % can contribute to the reduction of debris, and that the fluorine concentration F of 1.0 at % or more can contribute to the improvement of the friction characteristics. From the viewpoint of further reducing debris, the fluorine concentration F is preferably 4.8 at % or less, and more preferably 4.6 at % or less. From the viewpoint of further improving the friction characteristics, the fluorine concentration F is preferably 1.2 at % or more, more preferably 1.4 at % or more, and still more preferably 1.6 at % or more, 1.8 at % or more, 2.0 at % or more, 2.2 at % or more, 2.4 at % or more, and 2.6 at % or more in this order.

The fluorine concentration can be controlled by an amount of the fluorine-based compound used for forming the magnetic recording medium, and the like. In the present invention and the present specification, the term “fluorine-based compound” refers to a compound containing one or more fluorine atoms (F) per molecule.

### ΔC

ΔC is calculated by Equation: ΔC=C_{before}−C_{after} from the C_{before} and the C_{after} obtained by the method described above. Among various components that can be contained in the magnetic recording medium, a carbon-based compound that can function as a lubricant is generally a methanol-soluble component. Therefore, the present inventor considers that the ΔC, which is a difference in the C—H derived carbon concentration before and after the methanol extraction, can be an indicator of the presence amount of the carbon-based compound that can function as a lubricant in the extremely outermost surface layer portion of the magnetic layer. Then, the present inventor considers that the ΔC of 30.0 at % or less can contribute to the reduction of debris, and that the ΔC of 10.0 at % or more can contribute to the improvement of the friction characteristics. From the viewpoint of further reducing debris, the ΔC is preferably 29.0 at % or less, more preferably 27.0 at % or less, and still more preferably 25.0 at % or less. From the viewpoint of further improving the friction characteristics, the ΔC is preferably 10.5 at % or more, more preferably 11.0 at % or more, and still more preferably 11.5 at % or more, 12.0 at % or more, 12.5 at % or more, 13.0 at % or more, 13.5 at % or more, 14.0 at % or more, 14.5 at % or more, 15.0 at % or more, 15.5 at % or more, 16.0 at % or more, 16.5 at % or more, and 20.0 at % or more in this order.

The ΔC can be controlled by an amount of the carbon-based compound that is used for forming the magnetic recording medium and can function as a lubricant, and the like. In the present invention and the present specification, the term “carbon-based compound” refers to a compound containing one or more carbon atoms (C) per molecule.

Hereinafter, the magnetic recording medium will be described in more detail.

### Magnetic Layer

### Ferromagnetic Powder

As a ferromagnetic powder included in the magnetic layer, a well-known ferromagnetic powder as a ferromagnetic powder used in magnetic layers of various magnetic recording media can be used alone or in combination of two or more. From the viewpoint of improving recording density, it is preferable to use a ferromagnetic powder having a small average particle size. From this point, the average particle size of the ferromagnetic powder is preferably 50 nm or less, more preferably 45 nm or less, still more preferably 40 nm or less, still more preferably 35 nm or less, still more preferably 30 nm or less, still more preferably 25 nm or less, and still more preferably 20 nm or less. On the other hand, from the viewpoint of magnetization stability, the average particle size of the ferromagnetic powder is preferably 5 nm or more, more preferably 8 nm or more, still more preferably 10 nm or more, still more preferably 15 nm or more, and still more preferably 20 nm or more.

### Hexagonal Ferrite Powder

Preferred specific examples of the ferromagnetic powder include a hexagonal ferrite powder. For details of the hexagonal ferrite powder, for example, descriptions disclosed in paragraphs 0012 to 0030 of JP2011-225417A, paragraphs 0134 to 0136 of JP2011-216149A, paragraphs 0013 to 0030 of JP2012-204726A, and paragraphs 0029 to 0084 of JP2015-127985A can be referred to.

In the present invention and the present specification, the term “hexagonal ferrite powder” refers to a ferromagnetic powder in which a hexagonal ferrite crystal structure is detected as a main phase by X-ray diffraction analysis. The main phase refers to a structure to which the highest intensity diffraction peak in an X-ray diffraction spectrum obtained by X-ray diffraction analysis is attributed. For example, in a case where the highest intensity diffraction peak is attributed to a hexagonal ferrite crystal structure in an X-ray diffraction spectrum obtained by X-ray diffraction analysis, it is determined that the hexagonal ferrite crystal structure is detected as the main phase. In a case where only a single structure is detected by X-ray diffraction analysis, this detected structure is taken as the main phase. The hexagonal ferrite crystal structure includes at least an iron atom, a divalent metal atom, and an oxygen atom, as a constituent atom. The divalent metal atom is a metal atom that can be a divalent cation as an ion, and examples thereof may include an alkaline earth metal atom such as a strontium atom, a barium atom, and a calcium atom, and a lead atom. In the present invention and the present specification, the term “hexagonal strontium ferrite powder” refers to a powder in which a main divalent metal atom is a strontium atom, and the term “hexagonal barium ferrite powder” refers to a powder in which a main divalent metal atom is a barium atom. The main divalent metal atom refers to a divalent metal atom that accounts for the most on an at % basis among the divalent metal atoms included in the powder. Note that a rare earth atom is not included in the above divalent metal atom. The term “rare earth atom” in the present invention and the present specification is selected from the group consisting of a scandium atom (Sc), an yttrium atom (Y), and a lanthanoid atom. The lanthanoid atom is selected from the group consisting of a lanthanum atom (La), a cerium atom (Ce), a praseodymium atom (Pr), a neodymium atom(Nd), a promethium atom (Pm), a samarium atom (Sm), a europium atom (Eu), a gadolinium atom (Gd), a terbium atom (Tb), a dysprosium atom (Dy), a holmium atom (Ho), an erbium atom (Er), a thulium atom (Tm), an ytterbium atom (Yb), and a lutetium atom (Lu).

Hereinafter, the hexagonal strontium ferrite powder, which is one aspect of the hexagonal ferrite powder, will be described in more detail.

An activation volume of the hexagonal strontium ferrite powder is preferably in a range of 800 to 1600 nm³. The finely granulated hexagonal strontium ferrite powder having an activation volume in the above range is suitable for manufacturing a magnetic recording medium exhibiting excellent electromagnetic conversion characteristics. The activation volume of the hexagonal strontium ferrite powder is preferably 800 nm³ or more, and may be, for example, 850 nm³ or more. Further, from the viewpoint of further improving the electromagnetic conversion characteristics, the activation volume of the hexagonal strontium ferrite powder is more preferably 1500 nm³ or less, still more preferably 1400 nm³ or less, still more preferably 1300 nm³ or less, still more preferably 1200 nm³ or less, and still more preferably 1100 nm³ or less. The same applies to an activation volume of the hexagonal barium ferrite powder.

The term “activation volume” refers to a unit of magnetization reversal and is an index indicating the magnetic size of a particle. An activation volume described in the present invention and the present specification and an anisotropy constant Ku which will be described below are values obtained from the following relational expression between a coercivity He and an activation volume V, by performing measurement in a coercivity He measurement portion at a magnetic field sweep rate of 3 minutes and 30 minutes using a vibrating sample magnetometer (measurement temperature: 23° C.±1° C.). For a unit of the anisotropy constant Ku, 1 erg/cc=1.0×10⁻¹ J/m³.

$$Hc = 2 Ku / Ms \{ 1 - {[ ( kT / KuV ) ln ( At / 0.693 ) ]}^{1 / 2} \}$$

[In the above expression, Ku: anisotropy constant (unit: J/m³), Ms: saturation magnetization (Unit: kA/m), k: Boltzmann constant, T: absolute temperature (unit: K), V: activation volume (unit: cm³), A: spin precession frequency (unit: s⁻¹), t: magnetic field reversal time (unit: s)]

An index for reducing thermal fluctuation, in other words, for improving the thermal stability may include the anisotropy constant Ku. The hexagonal strontium ferrite powder preferably has Ku of 1.8×10⁵ J/m³ or more, and more preferably has Ku of 2.0×10⁵ J/m³ or more. Ku of the hexagonal strontium ferrite powder may be, for example, 2.5×10⁵ J/m³ or less. Here, since higher Ku means higher thermal stability, which is preferable, a value thereof is not limited to the values exemplified above.

The hexagonal strontium ferrite powder may or may not include a rare earth atom. In a case where the hexagonal strontium ferrite powder includes a rare earth atom, it is preferable to include a rare earth atom at a content (bulk content) of 0.5 to 5.0 at % with respect to 100 at % of an iron atom. In one aspect, the hexagonal strontium ferrite powder including a rare earth atom may have a rare earth atom surface layer portion uneven distribution property. In the present invention and the present specification, the “rare earth atom surface layer portion uneven distribution property” means that a rare earth atom content with respect to 100 at % of an iron atom in a solution obtained by partially dissolving the hexagonal strontium ferrite powder with an acid (hereinafter, referred to as a “rare earth atom surface layer portion content” or simply a “surface layer portion content” for a rare earth atom.) and a rare earth atom content with respect to 100 at % of an iron atom in a solution obtained by totally dissolving the hexagonal strontium ferrite powder with an acid (hereinafter, referred to as a “rare earth atom bulk content” or simply a “bulk content” for a rare earth atom.) satisfy a ratio of a rare earth atom surface layer portion content/a rare earth atom bulk content >1.0. A rare earth atom content in the hexagonal strontium ferrite powder described below is synonymous with the rare earth atom bulk content. On the other hand, partial dissolution using an acid dissolves a surface layer portion of a particle constituting the hexagonal strontium ferrite powder, and thus, a rare earth atom content in a solution obtained by partial dissolution is a rare earth atom content in a surface layer portion of a particle constituting the hexagonal strontium ferrite powder. A rare earth atom surface layer portion content satisfying a ratio of “rare earth atom surface layer portion content/rare earth atom bulk content >1.0” means that in a particle constituting the hexagonal strontium ferrite powder, rare earth atoms are unevenly distributed in a surface layer portion (that is, more than an inside). The surface layer portion in the present invention and the present specification means a partial region from a surface of a particle constituting the hexagonal strontium ferrite powder toward an inside.

In a case where the hexagonal strontium ferrite powder includes the rare earth atom, a rare earth atom content (bulk content) is preferably in a range of 0.5 to 5.0 at % with respect to 100 at % of an iron atom. It is considered that a bulk content in the above range of the included rare earth atom and uneven distribution of the rare earth atoms in a surface layer portion of a particle constituting the hexagonal strontium ferrite powder contribute to suppression of a decrease in reproduction output during repeated reproduction. It is supposed that this is because the hexagonal strontium ferrite powder includes a rare earth atom with a bulk content in the above range, and rare earth atoms are unevenly distributed in a surface layer portion of a particle constituting the hexagonal strontium ferrite powder, and thus it is possible to increase an anisotropy constant Ku. The higher a value of an anisotropy constant Ku is, the more a phenomenon called thermal fluctuation can be suppressed (in other words, thermal stability can be improved). By suppressing occurrence of thermal fluctuation, it is possible to suppress a decrease in reproduction output during repeated reproduction. It is supposed that uneven distribution of rare earth atoms in a particulate surface layer portion of the hexagonal strontium ferrite powder contributes to stabilization of spins of iron (Fe) sites in a crystal lattice of a surface layer portion, and thus, an anisotropy constant Ku may be increased.

From the viewpoint of further suppressing a decrease in reproduction output during repeated reproduction, the rare earth atom content (bulk content) is more preferably in a range of 0.5 to 4.5 at %, still more preferably in a range of 1.0 to 4.5 at %, and still more preferably in a range of 1.5 to 4.5 at %.

The bulk content is a content obtained by totally dissolving the hexagonal strontium ferrite powder. In the present invention and the present specification, unless otherwise noted, the content of an atom means a bulk content obtained by totally dissolving the hexagonal strontium ferrite powder. The hexagonal strontium ferrite powder including a rare earth atom may include only one kind of rare earth atom as the rare earth atom, or may include two or more kinds of rare earth atoms. The bulk content in a case of including two or more kinds of rare earth atoms is obtained for the total of two or more kinds of rare earth atoms. This also applies to other components in the present invention and the present specification. That is, unless otherwise noted, a certain component may be used alone or in combination of two or more. A content amount or a content in a case where two or more components are used refers to that for the total of two or more components.

In a case where the hexagonal strontium ferrite powder includes a rare earth atom, the included rare earth atom need only be any one or more of rare earth atoms. As a rare earth atom that is preferable from the viewpoint of further suppressing a decrease in reproduction output during repeated reproduction, there are a neodymium atom, a samarium atom, a yttrium atom, and a dysprosium atom, here, the neodymium atom, the samarium atom, and the yttrium atom are more preferable, and a neodymium atom is still more preferable.

In the hexagonal strontium ferrite powder having a rare earth atom surface layer portion uneven distribution property, the rare earth atoms need only be unevenly distributed in the surface layer portion of a particle constituting the hexagonal strontium ferrite powder, and the degree of uneven distribution is not limited. For example, for the hexagonal strontium ferrite powder having a rare earth atom surface layer portion uneven distribution property, a ratio of a surface layer portion content of a rare earth atom obtained by partial dissolution under dissolution conditions which will be described below to a bulk content of a rare earth atom obtained by total dissolution under dissolution conditions which will be described below, that is, “surface layer portion content/bulk content” exceeds 1.0 and may be 1.5 or more. The fact that “surface layer portion content/bulk content” is larger than 1.0 means that in a particle constituting the hexagonal strontium ferrite powder, rare earth atoms are unevenly distributed in the surface layer portion (that is, more than an inside). Further, a ratio of a surface layer portion content of a rare earth atom obtained by partial dissolution under dissolution conditions which will be described below to a bulk content of a rare earth atom obtained by total dissolution under the dissolution conditions which will be described below, that is, “surface layer portion content/bulk content” may be, for example, 10.0 or less, 9.0 or less, 8.0 or less, 7.0 or less, 6.0 or less, 5.0 or less, or 4.0 or less. Note that, in the hexagonal strontium ferrite powder having a rare earth atom surface layer portion uneven distribution property, the rare earth atoms need only be unevenly distributed in the surface layer portion of a particle constituting the hexagonal strontium ferrite powder, and the “surface layer portion content/bulk content” is not limited to the exemplified upper limit or lower limit.

The partial dissolution and the total dissolution of the hexagonal strontium ferrite powder will be described below. For the hexagonal strontium ferrite powder that exists as a powder, the partially and totally dissolved sample powder is taken from the same lot of powder. On the other hand, for the hexagonal strontium ferrite powder included in the magnetic layer of the magnetic recording medium, a part of the hexagonal strontium ferrite powder taken out from the magnetic layer is subjected to partial dissolution, and the other part is subjected to total dissolution. The hexagonal strontium ferrite powder can be taken out from the magnetic layer by a method described in a paragraph 0032 of JP2015-91747A, for example.

The partial dissolution means that dissolution is performed such that, at the end of dissolution, the residue of the hexagonal strontium ferrite powder can be visually checked in the solution. For example, by partial dissolution, it is possible to dissolve a region of 10 to 20 mass % of the particle constituting the hexagonal strontium ferrite powder with the total particle being 100 mass %. On the other hand, the total dissolution means that dissolution is performed such that, at the end of dissolution, the residue of the hexagonal strontium ferrite powder cannot be visually checked in the solution.

The partial dissolution and measurement of the surface layer portion content are performed by the following method, for example. Note that the following dissolution conditions such as the amount of sample powder are exemplified, and dissolution conditions for partial dissolution and total dissolution can be employed in any manner.

A container (for example, a beaker) containing 12 mg of the sample powder and 10 mL of 1 mol/L hydrochloric acid is held on a hot plate at a set temperature of 70° C. for 1 hour. The obtained solution is filtered by a membrane filter of 0.1 μm. Elemental analysis of the filtrated solution thus obtained is performed by an inductively coupled plasma (ICP) analyzer. In this way, the surface layer portion content of a rare earth atom with respect to 100 at % of an iron atom can be obtained. In a case where a plurality of kinds of rare earth atoms are detected by elemental analysis, the total content of all rare earth atoms is defined as the surface layer portion content. This also applies to the measurement of the bulk content.

On the other hand, the total dissolution and measurement of the bulk content are performed by the following method, for example.

A container (for example, a beaker) containing 12 mg of the sample powder and 10 mL of 4 mol/L hydrochloric acid is held on a hot plate at a set temperature of 80° C. for 3 hours. Thereafter, the same procedure as the partial dissolution and the measurement of the surface layer portion content is carried out, and the bulk content with respect to 100 at % of an iron atom can be obtained.

From the viewpoint of increasing the reproduction output in a case of reproducing data recorded on the magnetic recording medium, it is desirable that mass magnetization as of the ferromagnetic powder included in the magnetic recording medium is high. In this regard, the hexagonal strontium ferrite powder including a rare earth atom but not having the rare earth atom surface layer portion uneven distribution property tends to have a larger decrease in σs than that of the hexagonal strontium ferrite powder including no rare earth atom. With respect to this, it is considered that the hexagonal strontium ferrite powder having a rare earth atom surface layer portion uneven distribution property is preferable in suppressing such a large decrease in σs. In one aspect, as of the hexagonal strontium ferrite powder may be 45 A·m²/kg or more, and may be 47 A·m²/kg or more. On the other hand, from the viewpoint of noise reduction, σs is preferably 80 A·m²/kg or less and more preferably 60 A·m²/kg or less. σs can be measured using a well-known measuring device, such as a vibrating sample magnetometer, capable of measuring magnetic properties. In the present invention and the present specification, unless otherwise noted, the mass magnetization σs is a value measured at a magnetic field intensity of 15 kOe. A conversion coefficient of unit Oe (Oersted) into SI unit A/m is 10³/4π.

Regarding the content (bulk content) of a constituent atom of the hexagonal strontium ferrite powder, a strontium atom content may be, for example, in a range of 2.0 to 15.0 at % with respect to 100 at % of an iron atom. In one aspect, the hexagonal strontium ferrite powder may include only a strontium atom as a divalent metal atom. In another aspect, the hexagonal strontium ferrite powder may include one or more other divalent metal atoms in addition to a strontium atom. For example, a barium atom and/or a calcium atom may be included. In a case where the other divalent metal atoms other than the strontium atom are included, a content of the barium atom and a content of the calcium atom in the hexagonal strontium ferrite powder respectively can be, for example, in a range of 0.05 to 5.0 at % with respect to 100 at % of the iron atom.

As the hexagonal ferrite crystal structure, a magnetoplumbite type (also referred to as an “M type”), a W type, a Y type, and a Z type are known. The hexagonal strontium ferrite powder may have any crystal structure. The crystal structure can be checked by X-ray diffraction analysis. In the hexagonal strontium ferrite powder, a single crystal structure or two or more crystal structures may be detected by X-ray diffraction analysis. For example, according to one aspect, in the hexagonal strontium ferrite powder, only the M-type crystal structure may be detected by X-ray diffraction analysis. For example, M type hexagonal ferrite is represented by a composition formula of AFe₁₂O₁₉. Here, A represents a divalent metal atom, and in a case where the hexagonal strontium ferrite powder is the M type, A is only a strontium atom (Sr), or in a case where, as A, a plurality of divalent metal atoms are included, as described above, a strontium atom (Sr) accounts for the most on an at % basis. The divalent metal atom content of the hexagonal strontium ferrite powder is usually determined by the type of crystal structure of the hexagonal ferrite and is not particularly limited. The same applies to the iron atom content and the oxygen atom content. The hexagonal strontium ferrite powder may include at least an iron atom, a strontium atom, and an oxygen atom, and may further include a rare earth atom. Furthermore, the hexagonal strontium ferrite powder may or may not include atoms other than these atoms. As an example, the hexagonal strontium ferrite powder may include an aluminum atom (Al). A content of an aluminum atom may be, for example, 0.5 to 10.0 at % with respect to 100 at % of an iron atom. From the viewpoint of further suppressing a decrease in reproduction output during repeated reproduction, the hexagonal strontium ferrite powder includes an iron atom, a strontium atom, an oxygen atom, and a rare earth atom, and the content of atoms other than these atoms is preferably 10.0 at % or less, more preferably in a range of 0 to 5.0 at %, and may be 0 at % with respect to 100 at % of an iron atom. That is, in one aspect, the hexagonal strontium ferrite powder may not include atoms other than an iron atom, a strontium atom, an oxygen atom, and a rare earth atom. The content expressed in at % is obtained by converting a content of each atom (unit: mass %) obtained by totally dissolving the hexagonal strontium ferrite powder into a value expressed in at % using an atomic weight of each atom. Further, in the present invention and the present specification, the term “not include” for a certain atom means that a content measured by an ICP analyzer after total dissolution is 0 mass %. A detection limit of the ICP analyzer is usually 0.01 parts per million (ppm) or less on a mass basis. The term “not included” is used as a meaning including that an atom is included in an amount less than the detection limit of the ICP analyzer. In one aspect, the hexagonal strontium ferrite powder may not include a bismuth atom (Bi).

### Metal Powder

Preferred specific examples of the ferromagnetic powder include a ferromagnetic metal powder. For details of the ferromagnetic metal powder, descriptions disclosed in paragraphs 0137 to 0141 of JP2011-216149A and paragraphs 0009 to 0023 of JP2005-251351A can be referred to, for example.

### ε-Iron Oxide Powder

Preferred specific examples of the ferromagnetic powder include an ε-iron oxide powder. In the present invention and the present specification, the term “ε-iron oxide powder” refers to a ferromagnetic powder in which an ε-iron oxide crystal structure is detected as a main phase by X-ray diffraction analysis. For example, in a case where the highest intensity diffraction peak is attributed to an ε-iron oxide crystal structure in an X-ray diffraction spectrum obtained by X-ray diffraction analysis, it is determined that the ε-iron oxide crystal structure is detected as the main phase. As a method of manufacturing an ε-iron oxide powder, a manufacturing method from a goethite, a reverse micelle method, and the like are known. All of the manufacturing methods are well known. Regarding a method of manufacturing an ε-iron oxide powder in which a part of Fe is substituted with substitutional atoms such as Ga, Co, Ti, Al, or Rh, a description disclosed in J. Jpn. Soc. Powder Metallurgy Vol. 61 Supplement, No. S1, pp. S280 to S284, J. Mater. Chem. C, 2013, 1, pp. 5200 to 5206 can be referred to, for example. Note that the method of manufacturing the ε-iron oxide powder capable of being used as the ferromagnetic powder in the magnetic layer of the magnetic recording medium is not limited to the methods described here.

An activation volume of the ε-iron oxide powder is preferably in a range of 300 to 1500 nm³. The finely granulated ε-iron oxide powder having an activation volume in the above range is suitable for manufacturing a magnetic recording medium exhibiting excellent electromagnetic conversion characteristics. The activation volume of the ε-iron oxide powder is preferably 300 nm³ or more, and may be, for example, 500 nm³ or more. Further, from the viewpoint of further improving the electromagnetic conversion characteristics, the activation volume of the ε-iron oxide powder is more preferably 1400 nm³ or less, still more preferably 1300 nm³ or less, still more preferably 1200 nm³ or less, and still more preferably 1100 nm³ or less.

An index for reducing thermal fluctuation, in other words, for improving the thermal stability may include the anisotropy constant Ku. The ε-iron oxide powder preferably has Ku of 3.0×10⁴ J/m³ or more, and more preferably has Ku of 8.0×10⁴ J/m³ or more. Ku of the ε-iron oxide powder may be, for example, 3.0×10⁵ J/m³ or less. Here, since higher Ku means higher thermal stability, which is preferable, a value thereof is not limited to the values exemplified above.

From the viewpoint of increasing the reproduction output in a case of reproducing data recorded on the magnetic recording medium, it is desirable that mass magnetization as of the ferromagnetic powder included in the magnetic recording medium is high. In this regard, in one aspect, as of the ε-iron oxide powder may be 8 A·m²/kg or more, and may be 12 A·m²/kg or more. On the other hand, from the viewpoint of noise reduction, as of the ε-iron oxide powder is preferably 40 A·m²/kg or less and more preferably 35 A·m²/kg or less.

In the present invention and the present specification, unless otherwise noted, an average particle size of various powders such as ferromagnetic powders is a value measured by the following method using a transmission electron microscope.

The powder is imaged at an imaging magnification of 100000× with a transmission electron microscope, the image is printed on photographic printing paper or displayed on a display so that the total magnification of 500000× to obtain an image of particles configuring the powder. A target particle is selected from the obtained image of particles, an outline of the particle is traced by a digitizer, and a size of the particle (primary particle) is measured. The primary particles are independent particles without aggregation.

The measurement described above is performed regarding 500 particles randomly selected. An arithmetic average of the particle sizes of 500 particles thus obtained is an average particle size of the powder. As the transmission electron microscope, a transmission electron microscope H-9000 manufactured by Hitachi, Ltd. can be used, for example. In addition, the measurement of the particle size can be performed by well-known image analysis software, for example, image analysis software KS-400 manufactured by Carl Zeiss. An average particle size described in the section of Examples which will be described below is a value measured by using a transmission electron microscope H-9000 manufactured by Hitachi, Ltd. as the transmission electron microscope, and image analysis software KS-400 manufactured by Carl Zeiss as the image analysis software, unless otherwise noted. In the present invention and the present specification, the powder means an aggregate of a plurality of particles. For example, the ferromagnetic powder means an aggregate of a plurality of ferromagnetic particles. Further, the aggregate of the plurality of particles not only includes an aspect in which particles constituting the aggregate directly come into contact with each other, but also includes an aspect in which a binding agent or an additive which will be described below is interposed between the particles. The term “particle” is used to describe a powder in some cases.

As a method of taking a sample powder from the magnetic recording medium in order to measure the particle size, a method disclosed in a paragraph 0015 of JP2011-048878A can be employed, for example.

In the present invention and the present specification, unless otherwise noted, (1) in a case where the shape of the particle observed in the particle image described above is a needle shape, a fusiform shape, or a columnar shape (here, a height is greater than a maximum major diameter of a bottom surface), the size (particle size) of the particles configuring the powder is shown as a length of a long axis configuring the particle, that is, a long axis length, (2) in a case where the shape of the particle is a plate shape or a columnar shape (here, a thickness or a height is smaller than a maximum major diameter of a plate surface or a bottom surface), the particle size is shown as a maximum major diameter of the plate surface or the bottom surface, and (3) in a case where the shape of the particle is a sphere shape, a polyhedron shape, or an amorphous shape, and the long axis configuring the particles cannot be specified from the shape, the particle size is shown as an equivalent circle diameter. The equivalent circle diameter refers to a value obtained by a circle projection method.

In addition, regarding an average acicular ratio of the powder, a length of a short axis, that is, a short axis length of the particles is measured in the measurement described above, a value of (long axis length/short axis length) of each particle is obtained, and an arithmetic average of the values obtained regarding 500 particles is calculated. Here, unless otherwise noted, in a case of (1), the short axis length as the definition of the particle size is a length of a short axis configuring the particle, in a case of (2), the short axis length is a thickness or a height, and in a case of (3), the long axis and the short axis are not distinguished, thus, the value of (long axis length/short axis length) is assumed as 1, for convenience.

In addition, unless otherwise noted, in a case where the shape of the particle is specified, for example, in a case of definition of the particle size (1), the average particle size is an average long axis length, and in a case of the definition (2), the average particle size is an average plate diameter. In a case of the definition (3), the average particle size is an average diameter (also referred to as an average particle diameter).

The content (filling percentage) of the ferromagnetic powder of the magnetic layer is preferably in a range of 50 to 90 mass % and more preferably in a range of 60 to 90 mass %, with respect to the total mass of the magnetic layer. A high filling percentage of the ferromagnetic powder in the magnetic layer is preferable from the viewpoint of improving the recording density.

### Binding Agent

The magnetic recording medium can be a coating type magnetic recording medium, and can include a binding agent in the magnetic layer. The binding agent is one or more resins. As the binding agent, various resins usually used as a binding agent of a coating type magnetic recording medium can be used. For example, as the binding agent, a resin selected from a polyurethane resin, a polyester resin, a polyamide resin, a vinyl chloride resin, an acrylic resin obtained by copolymerizing styrene, acrylonitrile, or methyl methacrylate, a cellulose resin such as nitrocellulose, an epoxy resin, a phenoxy resin, and a polyvinylalkylal resin such as polyvinyl acetal or polyvinyl butyral can be used alone or a plurality of resins can be mixed with each other to be used. Among these, a polyurethane resin, an acrylic resin, a cellulose resin, and a vinyl chloride resin are preferable. These resins may be homopolymers or copolymers. These resins can be used as the binding agent even in a non-magnetic layer and/or a back coating layer which will be described below. For the above binding agent, descriptions disclosed in paragraphs 0028 to 0031 of JP2010-24113A can be referred to. In addition, the binding agent may be a radiation curable resin such as an electron beam curable resin. For the radiation curable resin, descriptions disclosed in paragraphs 0044 and 0045 of JP2011-048878A can be referred to.

An average molecular weight of the resin used as the binding agent can be, for example, 10,000 to 200,000 as a weight-average molecular weight. The weight-average molecular weight of the present invention and the present specification is a value obtained by performing polystyrene conversion of a value measured by gel permeation chromatography (GPC) under the following measurement conditions. The weight-average molecular weight described in the columns of Examples described below is a value obtained by performing polystyrene conversion of a value measured under the following measurement conditions. The binding agent may be used in an amount of, for example, 1.0 to 30.0 parts by mass with respect to 100.0 parts by mass of the ferromagnetic powder.
GPC device: HLC-8120 (manufactured by Tosoh Corporation)
Column: TSK gel Multipore HXL-M (manufactured by Tosoh Corporation, 7.8 mm inner diameter (ID)×30.0 cm)
Eluent: tetrahydrofuran (THF)

### Curing Agent

A curing agent can also be used together with the resin which can be used as the binding agent. As the curing agent, in one aspect, a thermosetting compound which is a compound in which a curing reaction (crosslinking reaction) proceeds due to heating can be used, and in another aspect, a photocurable compound in which a curing reaction (crosslinking reaction) proceeds due to light irradiation can be used. The curing reaction proceeds in a magnetic layer forming step, whereby at least a part of the curing agent can be included in the magnetic layer in a state of being reacted (crosslinked) with other components such as the binding agent. The same applies to the layer formed using this composition in a case where the composition used to form the other layer includes a curing agent. The preferred curing agent is a thermosetting compound, and polyisocyanate is suitable for this. For details of the polyisocyanate, descriptions disclosed in paragraphs 0124 and 0125 of JP2011-216149A can be referred to. The curing agent can be used in the composition for forming a magnetic layer in an amount of, for example, 0 to 80.0 parts by mass, and preferably 50.0 to 80.0 parts by mass from the viewpoint of improving a strength of the magnetic layer, with respect to 100.0 parts by mass of the binding agent.

### Additive

The magnetic layer may include one or more kinds of additives, as necessary. As the additive, a commercially available product can be appropriately selected and used according to a desired property. Alternatively, a compound synthesized by a well-known method can be used as the additive. The additive can be used in any amount. Examples of the additive include the curing agent described above. In addition, examples of the additive which can be included in the magnetic layer include a non-magnetic powder (for example, an inorganic powder or carbon black), a lubricant, a dispersing agent, a dispersing assistant, an antibacterial agent, an antistatic agent, an antioxidant, and the like. For the dispersing agent, descriptions disclosed in paragraphs 0061 and 0071 of JP2012-133837A can be referred to. The dispersing agent may be added to a composition for forming a non-magnetic layer. For the dispersing agent that can be added to the composition for forming a non-magnetic layer, a description disclosed in a paragraph 0061 of JP2012-133837A can be referred to. As the non-magnetic powder that can be contained in the magnetic layer, a non-magnetic powder which can function as an abrasive, or a non-magnetic powder which can function as a protrusion forming agent which forms protrusions appropriately protruded from the magnetic layer surface (for example, carbon black or non-magnetic colloidal particles) is used. For example, for the abrasive, descriptions disclosed in paragraphs 0030 to 0032 of JP2004-273070A can be referred to. As the abrasive, it is preferable to use an abrasive having a specific surface area (hereinafter, referred to as a “BET specific surface area”) measured by a Brunauer-Emmett-Teller (BET) method of 14 μm²/g or more and 40 μm²/g or less. An average particle size of the protrusion forming agent is preferably in a range of 30 to 200 nm, and more preferably in a range of 50 to 100 nm.

### Fatty Acid, Fatty Acid Ester, and Fatty Acid Amide

The magnetic recording medium can contain one or more components selected from the group consisting of a fatty acid, a fatty acid ester, and a fatty acid amide in a portion on the non-magnetic support on the magnetic layer side. The portion on the magnetic layer side may contain only one component selected from a fatty acid, a fatty acid ester, and a fatty acid amide, or may contain two or three components. In addition, only one or two or more fatty acids may be contained as the fatty acid. The same applies to the fatty acid ester and the fatty acid amide. In the present invention and the present specification, the term “portion on the non-magnetic support on the magnetic layer side” refers to a magnetic layer in a case of a magnetic recording medium including the magnetic layer directly on the non-magnetic support, and refers to a magnetic layer and/or a non-magnetic layer in a case of a magnetic recording medium including the non-magnetic layer between the non-magnetic support and the magnetic layer, which will be described below. The term “portion on the non-magnetic support on the magnetic layer side” is also simply described as a “portion on the magnetic layer side”. The presence on the surface of the magnetic recording medium on the magnetic layer side is also included in the inclusion in the portion on the magnetic layer side.

The fatty acid, the fatty acid ester, and the fatty acid amide are generally methanol-soluble components that can be extracted by the methanol extraction treatment described above, and are components that can function as a lubricant. The lubricant is generally broadly divided into a fluid lubricant and a boundary lubricant. A fatty acid ester is said to be a component that can function as a fluid lubricant, whereas a fatty acid and a fatty acid amide are said to be components that can function as boundary lubricants. The present inventor considers that the ΔC is an index for the presence amount of one or more components selected from the group consisting of a fatty acid and a fatty acid amide that can function as a boundary lubricant in the extremely outermost surface layer portion of the magnetic layer.

Examples of the fatty acid include lauric acid, myristic acid, palmitic acid, stearic acid, oleic acid, linoleic acid, linolenic acid, behenic acid, erucic acid, elaidic acid, stearic acid, myristic acid, and palmitic acid are preferable, and stearic acid is more preferable. The fatty acid may be included in the magnetic layer in a form of a salt such as a metal salt.

Examples of the fatty acid ester include esters of the above-described exemplified various fatty acids. Specific examples thereof include butyl myristate, butyl palmitate, butyl stearate, neopentyl glycol dioleate, sorbitan monostearate, sorbitan distearate, sorbitan tristearate, oleyl oleate, isocetyl stearate, isotridecyl stearate, octyl stearate, isooctyl stearate, amyl stearate, and butoxyethyl stearate.

Examples of the fatty acid amide include amides of the above-described exemplified various fatty acids. Specific examples thereof include amides of the various fatty acids, for example, lauric acid amide, myristic acid amide, palmitic acid amide, and stearic acid amide.

For the fatty acid and a derivative of the fatty acid (such as amide and ester), a fatty acid-derived moiety of the fatty acid derivative preferably has a structure which is the same as or similar to that of the fatty acid used in combination. For example, in a case where stearic acid is used as the fatty acid, it is preferable to use stearic acid amide and/or stearic acid ester in combination.

In one aspect, the magnetic recording medium containing one or more components selected from the group consisting of a fatty acid, a fatty acid ester, and a fatty acid amide in the portion on the magnetic layer side can be manufactured by forming the magnetic layer using the composition for forming a magnetic layer containing one or more of the above components. In addition, in one aspect, the magnetic recording medium containing one or more of the components in the portion on the magnetic layer side can be manufactured by forming the non-magnetic layer using the composition for forming a non-magnetic layer containing one or more of the above components. In addition, in one aspect, the magnetic recording medium containing one or more of the components in the portion on the magnetic layer side can be manufactured by forming the non-magnetic layer using the composition for forming a non-magnetic layer containing one or more of the above components and the magnetic layer using the composition for forming a magnetic layer containing one or more of the above components. The non-magnetic layer can play a role of holding a component that can function as a lubricant such as a fatty acid, a fatty acid ester, a fatty acid amide, and a fatty acid amide, and supplying the component to the magnetic layer. The lubricant such as a fatty acid, a fatty acid ester, and a fatty acid amide included in the non-magnetic layer may be transferred to the magnetic layer and present in the magnetic layer.

A content of a fatty acid in the composition for forming a magnetic layer is preferably 0.50 to 3.00 parts by mass per 100.00 parts by mass of the ferromagnetic powder.

A content of a fatty acid ester in the composition for forming a magnetic layer is, for example, 0 to 10.00 parts by mass, and preferably 1.00 to 7.00 parts by mass per 100.00 parts by mass of the ferromagnetic powder.

A content of a fatty acid amide in the composition for forming a magnetic layer is, for example, 0 to 1.00 part by mass, and preferably 0.10 to 1.00 part by mass per 100.0 parts by mass of the ferromagnetic powder.

A content of a fatty acid in the composition for forming a non-magnetic layer is preferably 0.50 to 3.00 parts by mass per 100.0 parts by mass of the non-magnetic powder. A content of the fatty acid ester in the composition for forming a non-magnetic layer is, for example, 0 to 10.00 parts by mass, and preferably 0 to 7.00 parts by mass per 100.0 parts by mass of the non-magnetic powder. A content of the fatty acid amide in the composition for forming a non-magnetic layer is, for example, 0 to 1.00 part by mass, and preferably 0.10 to 1.00 part by mass per 100.0 parts by mass of the non-magnetic powder.

### Fluorine-Based Compound

In one aspect, the magnetic recording medium can contain one or more kinds of fluorine-based compounds in the portion on the magnetic layer side. As the fluorine-based compound, one kind of a commercially available compound or a compound that can be synthesized by a well-known method can be used, or two or more kinds thereof can be mixed and used in an arbitrary ratio. The fluorine atom can be contained in the fluorine-based compound in various aspects, for example, fluorine-containing substituents such as —CF₃, —CHF₂, and —CH₂F. As the fluorine-based compound, a compound having a reactive group (hereinafter, referred to as a “crosslinking group”) capable of forming a crosslinked structure is preferable. Examples of the crosslinking group include an epoxy group and an isocyanate group. Further, examples thereof include a crosslinking group described below. For example, it is supposed that an anchoring effect of the fluorine-based compound is obtained by direct formation of a crosslinking structure between such a crosslinking group of the fluorine-based compound and other components (for example, a binding agent) contained in the magnetic layer. The present inventor considers that this point can contribute to making the contact angle with water equal to or more than 96 degrees, which is measured on the surface of the magnetic layer of the magnetic recording medium in which the fluorine concentration F is less than 5.0 at % and the ΔC is 20.0 at % or less.

Specific examples of a preferred fluorine-based compound for controlling the contact angle with water, which is measured on the surface of the magnetic layer of the magnetic recording medium in which the fluorine concentration F is less than 5.0 at % and the ΔC is 20.0 at % or less, to 96 degrees or more, include a crosslinking group-containing fluorine-containing polystyrene derivative containing a repeating unit represented by Formula [1] in a range of 1 mass % or more and 99 mass % or less and a crosslinking group-containing repeating unit in a range of 1 mass % or more and 95 mass % or less. Such a crosslinking group-containing fluorine-containing polystyrene derivative can be included in the magnetic recording medium in a form of a crosslinked substance formed by a crosslinking reaction of at least a part of the crosslinking group.

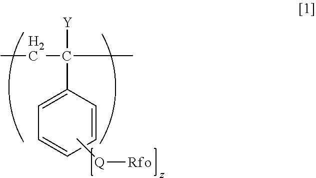

In Formula [1], Y represents a hydrogen atom or an alkyl group having 6 or less carbon atoms, Q represents a divalent group that contains at least one ether bond and has a total number of carbon atoms of 5 or less, and Rf₀ represents a monovalent perfluoroether group that contains at least one ether group and may contain one hydrogen atom with a total number of carbon atoms of 25 or less. z represents an integer in a range of 1 to 3. A bonding position of Q to an aromatic nucleus may be any of an ortho-position, a meta-position, or a para-position with respect to a bonding position between the aromatic nucleus and a main chain of the polymer. A part or all of the hydrogen atoms bonded to the aromatic nucleus in Formula [1] may be substituted with a fluorine atom.

Hereinafter, Formula [1] will be described in more detail.

Y in Formula [1] is a hydrogen atom or an alkyl group having 6 or less carbon atoms. The alkyl group having 6 or less carbon atoms may be any of a linear alkyl group or a branched alkyl group, and specific examples thereof include a methyl group, an ethyl group, an n (normal)-propyl group, an isopropyl group, an n-butyl group, a tert (tertiary)-butyl group, an isobutyl group, a sec (secondary)-butyl group, an n-amyl group, and an n-hexyl group. Y is preferably a hydrogen atom or an alkyl group having 4 or less carbon atoms, and particularly preferably a hydrogen atom or a methyl group.

Q in Formula [1] is a divalent group that contains at least one ether bond and has a total number of carbon atoms of 5 or less, and is, for example, a divalent group represented by Formula [2].

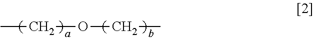

In Formula [2], a is 0 or 1, and b is 0 or an integer in a range of 1 to 3. A bonding site on the right side of Formula [2] is a site to be bonded to Rf₀.

Examples of Q include —O—, —OCH₂—, —OCH₂CH₂—, —OCH₂CH₂CH₂—, —OCH₂CH₂CH₂CH₂—, —OCH(CH₃)CH₂—, —OCH₂CH(CH₃)—, —OCH₂CH(OH)CH₂—, —OCH₂CH(OH)CH₂OCH₂—, —CH₂O—, —CH₂OCH₂—, —CH₂OCH₂CH₂—, —CH₂OCH₂CH₂CH₂—, —CH₂OCH₂CH₂CH₂CH₂—, —CH₂OCH₂CH(CH₃)OCH₂—, —OCH₂CH₂OCH₂—, —OCH₂CH₂OCH₂CH₂—, —CH₂OCH₂CH₂OCH₂—, and —CH₂OCH₂CH₂OCH₂CH₂— (the bonding site on the right side of each group is a site to be bonded to Rf₀).

Among the above, —O—, —OCH₂—, —OCH₂CH₂—, —CH₂OCH₂—, and —CH₂OCH₂CH₂— are preferable because a polymer can be easily synthesized, —O—, —OCH₂—, and —CH₂OCH₂— are more preferable, and —O— is particularly preferable because chemical stability is particularly excellent.

Rf₀ in Formula [1] is a monovalent perfluoroether group that contains at least one ether bond and may contain one hydrogen atom, and the total number of carbon atoms in Rf₀ is 25 or less. A ratio of [total number of carbon atoms/number of ether bonds] in Rf₀ is generally 2.0 or more and 9.0 or less, preferably 2.2 or more and 8.0 or less, more preferably 3.3 or more and 6.0 or less, and particularly preferably 3.5 or more and 5.0 or less.

Examples of Rf₀ include a group represented by Formula [3].

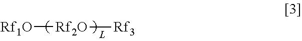

In Formula [3], Rf₁ is a perfluoroalkyl group having 7 or less carbon atoms, Rf₂ is one or a plurality of kinds of perfluoroalkylene groups selected from linear or branched perfluoroalkylene groups having 4 or less carbon atoms, Rf₃ is a perfluoroalkylene group having 3 or less carbon atoms or a polyfluoroalkylene group having a structure in which one fluorine atom of a perfluoroalkylene group having 3 or less carbon atoms is substituted with a hydrogen atom, and L is 0 or an integer in a range of 1 to 10.

Examples of R_{f1} include a linear or branched perfluoroalkyl group having 7 or less carbon atoms. A perfluoroalkyl group having 6 or less carbon atoms is preferable, and a perfluoroalkyl group having 3 or less carbon atoms is more preferable.

Specific examples of Rf₁ include CF₃—, CF₃CF₂—, CF₃CF₂CF₂—, (CF₃)₂CF—, CF₃CF₂CF₂CF₂—, CF₃CF₂CF₂CF₂CF₂—, CF₃CF₂CF₂CF₂CF₂CF₂—, and CF₃CF₂CF₂CF₂CF₂CF₂CF₂—. Among these, CF₃CF₂CF₂—, CF₃CF₂CF₂CF₂— and CF₃CF₂CF₂CF₂CF₂CF₂— are preferable, and CF₃CF₂CF₂— is particularly preferable because it is easy to synthesize.

Rf₂ is one or a plurality of kinds of perfluoroalkylene groups selected from linear or branched perfluoroalkylene groups having 4 or less carbon atoms. The number of carbon atoms in Rf₂ is usually in a range of 1 to 4, preferably in a range of 1 to 3, and particularly preferably 3.

Specific examples of Rf₂ include —CF(CF₃)CF₂—, —CF(CF₃)—, —CF₂—, —CF₂CF₂—, —CF₂CF₂CF₂—, —CF₂CF₂CF₂CF₂—, and —CF₂CF(CF₃)CF₂—. Among these, —CF(CF₃)CF₂—, —CF₂—, —CF₂CF₂—, and —CF₂CF₂CF₂— are preferable, and —CF(CF₃)CF₂— and —CF₂CF₂CF₂— are particularly preferable because it is easy to synthesize. A bonding site on the right side of each group of the specific examples of Rf₂ is a site to be bonded to an oxygen atom in the (Rf₂O) unit in Formula [3].

L in Formula [3] is 0 or an integer in a range of 1 to 10, preferably 0 or an integer in a range of 1 to 6, more preferably 0 or an integer in a range of 1 to 3, still more preferably 0 or an integer in a range of 1 to 2, and particularly preferably 0 or 1.

In the (Rf₂O)_{L} segment in Formula [3], in a case where Rf₂ is composed of a plurality of kinds of perfluoroalkylene groups, different kinds of Rf₂'s may be randomly mixed and arranged, as in —CF(CF₃)CF₂O—CF₂CF₂CF₂O—CF(CF₃)CF₂O— . . . , or a plurality of Rf₂'s of the same kind may be arranged.

In a case where Rf₂ consists of a plurality of kinds of perfluoroalkylene groups, specific examples of (Rf₂O)_{L} include a group represented by Formula [4].

—[CF(CF₃)CF₂O]ₙ₁—[CF₂CF₂CF₂O]ₙ₂—[CF₂CF₂O]ₙ₃—[CF₂O]ₙ₄ [4]

In Formula [4], n1, n2, n3, and n4 are each independently 0 or an integer in a range of 1 to 6. The sum (n1+n2+n3+n4) of n1, n2, n3, and n4 is the same as L in Formula [3].

Rf₃ is a perfluoroalkylene group having 3 or less carbon atoms or a polyfluoroalkylene group having a structure in which one fluorine atom of a perfluoroalkylene group having 3 or less carbon atoms is substituted with a hydrogen atom.

Specific examples of Rf₃ include —CF₂—, —CF₂CF₂—, —CF(CF₃)—, —CF₂CF₂CF₂—, —CF(CF₃)CF₂—, —CF₂CF(CF₃)—, —CHFCF₂—, and —CF₂CHFCF₂—. Among these, —CF₂CF₂—, —CF(CF₃)—, and —CHFCF₂— are preferable, and —CHFCF₂— is particularly preferable because it is easy to synthesize. A bonding site on the right side of each group of the specific examples of Rf₃ is a site to be bonded to Q.

Specific examples of Rf₀ include a group represented by Formula [R-1], a group represented by Formula [R-2], a group represented by Formula [R-3], and a group represented by Formula [R-4].

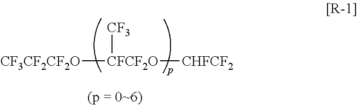

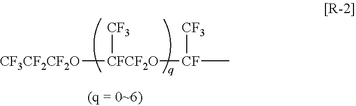

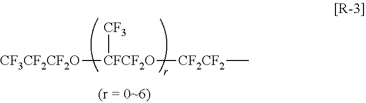

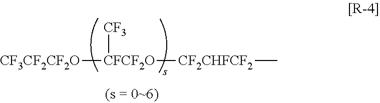

Specific examples of the group represented by Formula [R-1] include CF₃CF₂CF₂OCHFCF₂—, CF₃CF₂CF₂OCF(CF₃)CF₂OCHFCF₂—, CF₃CF₂CF₂OCF(CF₃)CF₂OCF(CF₃)CF₂OCHFCF₂—, and CF₃CF₂CF₂OCF(CF₃)CF₂OCF(CF₃)CF₂OCF(CF₃)CF₂OCHFCF₂—.

In addition, specific examples of the group represented by Formula [R-2], Formula [R-3], or Formula [R-4] include a group having a structure in which the terminal CHFCF₂ group of each structure exemplified as the specific examples of the group represented by Formula [R-1] is substituted with a CF(CF₃) group, a CF₂CF₂ group, or a CF₂CHFCF₂ group.

In addition, Rf₀ may have a structure in which a terminal group CF₃CF₂CF₂ in each group of Formula [R-1], Formula [R-2], Formula [R-3], or Formula [R-4] is substituted with a linear or branched perfluoroalkyl group having 1 to 7 carbon atoms, preferably 1 to 6 carbon atoms. Examples of the perfluoroalkyl group include CF₃—, CF₃CF₂—, (CF₃)₂CF—, CF₃CF₂CF₂CF₂—, CF₃CF₂CF₂CF₂CF₂—, and CF₃CF₂CF₂CF₂CF₂CF₂—.

z in Formula [1] is an integer in a range of 1 to 3, and from the viewpoint of ease of synthesis, it is more preferable that z is 1.

A bonding position of Q in Formula [1] to an aromatic nucleus may be any of an ortho-position, a meta-position, or a para-position with respect to a bonding position between the aromatic nucleus and a main chain of the polymer, and is preferably a para-position from the viewpoint of ease of synthesis and ease of obtaining of a raw material.

A part or all of the hydrogen atoms bonded to the aromatic nucleus in Formula [1] may be substituted with a fluorine atom. From the viewpoint of ease of synthesis, it is more preferable to be not substituted with a fluorine atom.

The repeating unit represented by Formula [1] is preferably a repeating unit represented by Formula [1-1], and more preferably a repeating unit represented by Formula [1-2].

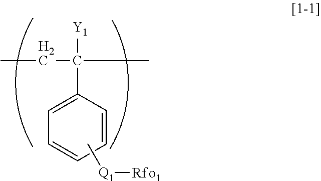

In Formula [1-1], Y₁ represents a hydrogen atom or a methyl group, and Q₁ represents a divalent group containing an ether bond having 3 or less carbon atoms. Rf₀₁ is Rfa₁-O—[CF(CF₃)CF₂O]ₘ₁—[CF₂CF₂CF₂O]ₘ₂—[CF₂CF₂O]ₘ₃—[CF₂O]ₘ₄-Rfc₁-, in which Rfa₁ represents a perfluoroalkyl group having 1 to 6 carbon atoms, m1, m2, m3, and m4 each independently represent 0 or an integer in a range of 1 to 6, the sum (m1+m2+m3+m4) of m1, m2, m3, and m4 is 0 or an integer in a range of 1 to 6, and Rfc₁ represents a perfluoroalkylene group that has 3 or less carbon atoms and may include one hydrogen atom.

Hereinafter, Formula [1-1] will be described in more detail.

Q₁ is a divalent group containing an ether bond having 3 or less carbon atoms, and specific examples thereof include —O—, —OCH₂—, —CH₂O—, —OCH₂CH₂—, —CH₂OCH₂—, and —CH₂OCH₂CH₂—. As Q₁, —O—, —CH₂OCH₂—, or —OCH₂— is more preferable, and —O— is particularly preferable. A bonding site on the right side of each group of the specific examples of Q₁ is a site to be bonded to Rf₀₁ in Formula [1-1].

The sum (m1+m2+m3+m4) of m1, m2, m3, and m4 is 0 or an integer in a range of 1 to 6, preferably 0 to 3, more preferably 0 to 2, and particularly preferably 0 or 1. Rfc₁ is a perfluoroalkylene group that has 3 or less carbon atoms and may include one hydrogen atom, and specific examples thereof include —CF₂CF₂—, —CF(CF₃)—, —CF₂—, —CF₂CHFCF₂—, and —CHFCF₂—. As Rfc₁, —CF(CF₃)— and —CHFCF₂— are more preferable, and —CHFCF₂— is particularly preferable. A bonding site on the right side of each group of the specific examples of Rfc₁ is a site to be bonded to Q₁ in Formula [1-1].

A bonding position of Q₁ in Formula [1-1] to an aromatic nucleus may be any of an ortho-position, a meta-position, or a para-position with respect to a bonding position between the aromatic nucleus and a main chain of the polymer, and is preferably a para-position from the viewpoint of ease of synthesis and ease of obtaining of a raw material.

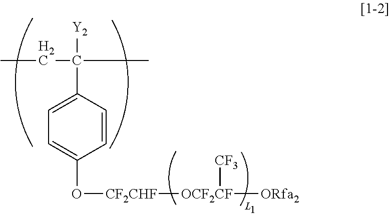

In Formula [1-2], Y₂ represents a hydrogen atom or a methyl group, L₁ is 0 or an integer in a range of 1 to 6, and Rfa₂ represents a perfluoroalkyl group having 1 to 6 carbon atoms.

L₁ is 0 or an integer in a range of 1 to 6, preferably 0 to 4, more preferably 0 to 2, and particularly preferably 0 or 1. In addition, Rfa₂ is a perfluoroalkyl group having 1 to 6 carbon atoms, preferably a perfluoroalkyl group having 2 to 4 carbon atoms, and particularly preferably CF₃CF₂CF₂—.

The fluorine-containing polystyrene derivative containing the repeating unit represented by Formula [1], Formula [1-1], or Formula [1-2] can be manufactured by a reaction between a reactive group-containing polystyrene derivative such as a polymer containing a p-hydroxystyrene type repeating unit or a polymer containing a repeating unit derived from p-chloromethylstyrene, and a perfluoro(poly)ether compound or a polyfluoro(poly)ether compound containing an active terminal group. For example, the polystyrene derivative containing the repeating unit of Formula [1-2] can be manufactured by an addition reaction between the polymer containing a p-hydroxystyrene type repeating unit and CF₂═CF—[OCF₂CF(CF₃)]_{L1}—ORfa₂ type polymer (L₁ and Rfa₂ are the same as those in Formula [1-2]).

In addition, the fluorine-containing polystyrene derivative containing the repeating unit represented by Formula [1] can also be manufactured by copolymerization of a monomer having a structure of CH₂═CY-Ph-[Q-Rf₀]_{z} (Y, Q, Rf₀, and z are the same as those in Formula [1], and Ph is an abbreviation for a phenylene group).

The content of the repeating unit represented by Formula [1] (preferably Formula [1-1] and more preferably Formula [1-2]) in the crosslinking group-containing fluorine-containing polystyrene derivative is 1 mass % or more and 99 mass % or less. A lower limit of the content of the repeating unit represented by Formula [1] in the crosslinking group-containing fluorine-containing polystyrene derivative is 1 mass % or more, 5 mass % or more, 10 mass % or more, 30 mass % or more, or 50 mass % or more. In addition, an upper limit of the content of the above repeating unit is 99 mass % or less, and may be 90 mass % or less, 80 mass % or less, or 70 mass % or less.

The crosslinking group-containing fluorine-containing polystyrene derivative contains a repeating unit containing a crosslinking group in a range of 1 mass % or more and 95 mass % or less, in addition to the repeating unit represented by Formula [1]. As the crosslinking group-containing repeating unit in the crosslinking group-containing fluorine-containing polystyrene derivative, for example, a repeating unit containing at least one kind of a crosslinking group selected from an active hydrogen-containing group, a carbon-carbon multiple bond-containing group, an epoxy group, an isocyanate group, and an alkoxysilane group is preferable. Examples of the active hydrogen-containing group include a hydroxy group (a phenolic hydroxy group and an alcoholic hydroxy group), an amino group, a thiol group, and a carboxyl group. Examples of the carbon-carbon multiple bond-containing group include a carbon-carbon double bond-containing group such as an acrylate group, a methacrylate group, a styrene group, an allyl group, a vinyloxy group, a trifluorovinyloxy group (CF₂═CFO— group), and a maleimide group, and a carbon-carbon triple bond-containing group such as a propargyl group or an ethynyl group. Examples of the epoxy group include a glycidyl group linked to various groups. Examples of the isocyanate group include an aliphatic isocyanate group and an aromatic isocyanate group. Examples of the alkoxysilane group include a trialkoxysilane group, a dialkoxymonoalkylsilane group, and a monoalkoxydialkylsilane group.

The crosslinking group in the repeating unit containing a crosslinking group can be subjected to a crosslinking reaction in various ways. Examples thereof include the following crosslinking reaction.

(i) A type in which crosslinking is performed by a reaction between an active hydrogen type crosslinking group and a polyfunctional substance (for example: crosslinking by a reaction between an active hydrogen (alcohol, phenol, amine, thiol, carboxylic acid, or the like) type crosslinking group and a polyfunctional compound (polyvalent isocyanate, polyvalent epoxy, or the like)).

(ii) A type in which crosslinking is performed by a reaction between a highly active crosslinking group and a polyfunctional substance (for example: crosslinking by a reaction between an isocyanate type crosslinking group or an epoxy group type crosslinking group and a polyvalent active hydrogen compound (polyhydric alcohol, polyhydric phenol, polyhydric amine, polyhydric thiol, or polyhydric carboxylic acid type compound)).

(iii) A type in which a single kind of crosslinking group is polymerized to perform crosslinking (for example: a (meth)acrylate type crosslinking group, a styrenyl type crosslinking group, an epoxy type crosslinking group, an oxetane type crosslinking group, or an episulfide type crosslinking group, examples of the polymerization method: radical polymerization, cationic polymerization, anionic polymerization, thermal polymerization, and ultraviolet irradiation).

The (meth)acrylate includes acrylate and methacrylate.

(iv) A type in which several crosslinking groups of a single kind are linked to perform crosslinking (for example, an ethynyl or propargyl type crosslinking group, an alkoxysilane type crosslinking group, or a trifluorovinyloxy type crosslinking group).

Specific examples of the repeating unit containing a crosslinking group in the crosslinking group-containing fluorine-containing polystyrene derivative are exemplified below. Note that the repeating unit containing a crosslinking group in the crosslinking group-containing fluorine-containing polystyrene derivative is not limited to this.

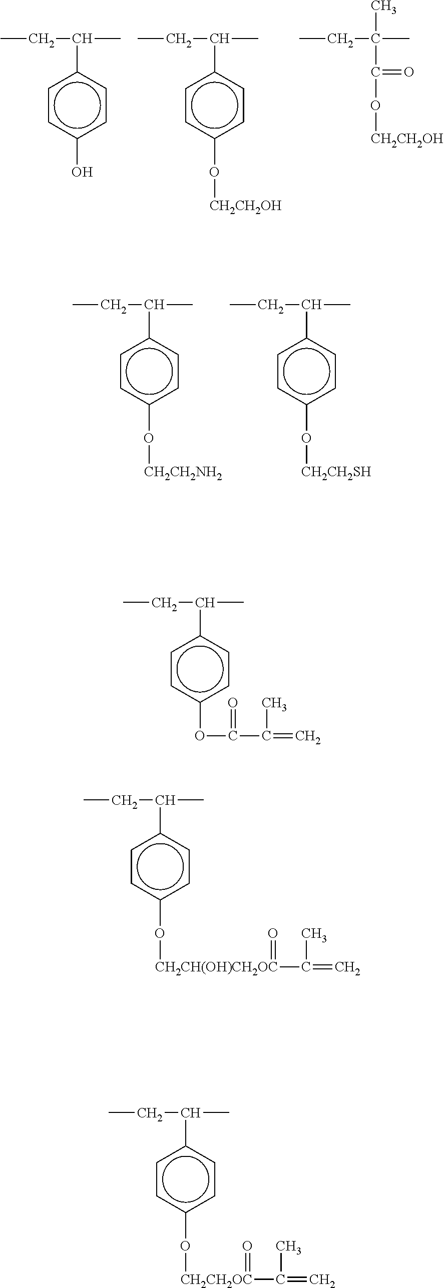

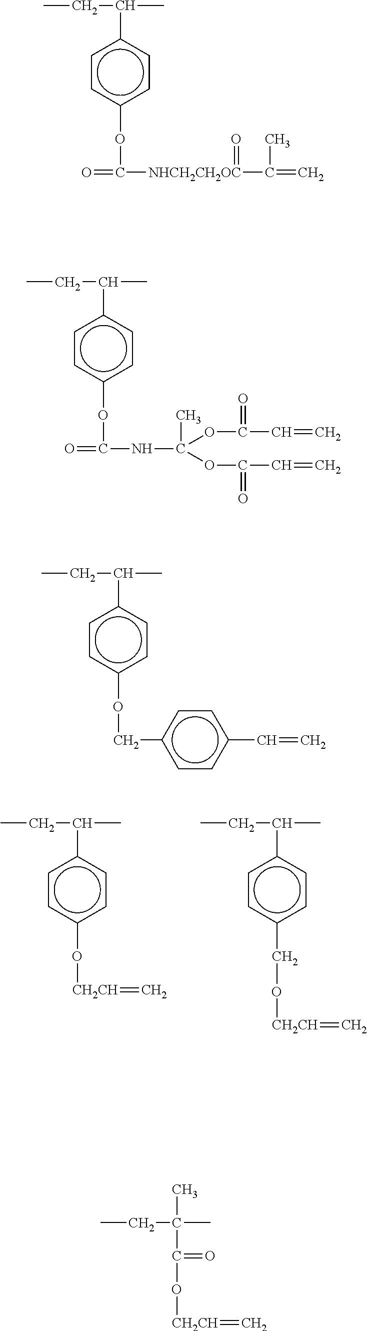

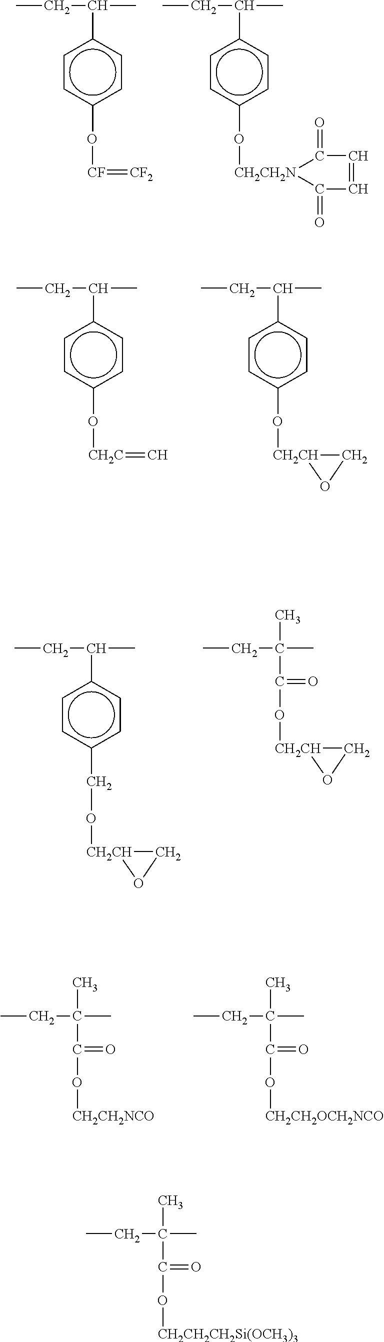

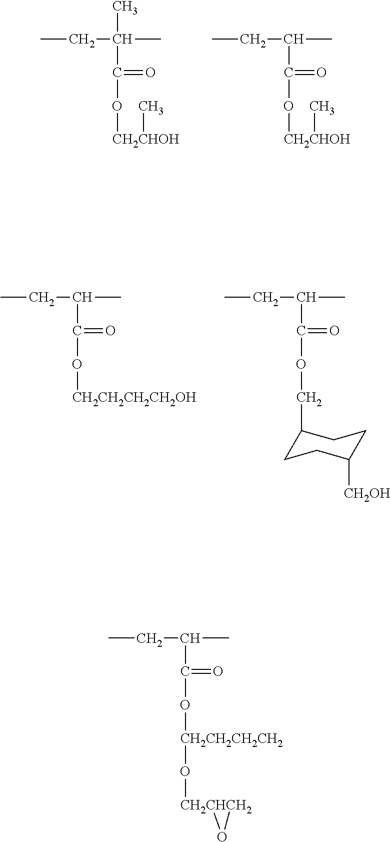

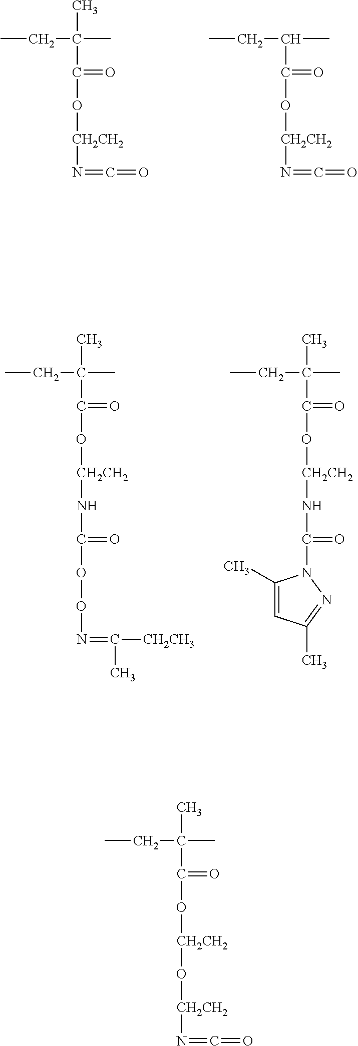

The crosslinking group-containing repeating unit in the crosslinking group-containing fluorine-containing polystyrene derivative can be introduced by various methods.

For example, a polymer containing a p (para)-hydroxystyrene unit as a repeating unit can be manufactured by a hydrolysis reaction of a polymer containing a repeating unit derived from p-acetoxystyrene. The p-hydroxystyrene unit can be used as a phenolic active hydrogen type crosslinking group. Further, the p-hydroxystyrene unit can be easily converted into various crosslinking group-containing repeating units by utilizing the high reactivity thereof. Examples thereof include an example in which an —OH group of the p-hydroxystyrene unit is converted into various kinds of crosslinking groups as described below. In addition, an aliphatic alcohol group of a copolymer containing a repeating unit such as 2-hydroxyethyl methacrylate or 2-hydroxypropyl methacrylate can also be converted into various kinds of crosslinking groups described below.

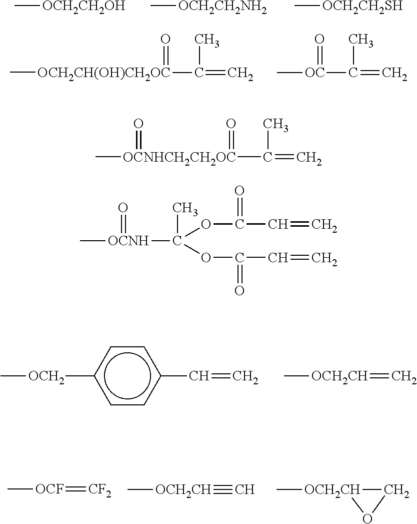

The crosslinking group-containing repeating unit in the crosslinking group-containing fluorine-containing polystyrene derivative can be introduced by copolymerization of a vinyl-polymerizable monomer containing various crosslinking groups and a polystyrene derivative monomer that forms a repeating unit represented by Formula [1] (preferably Formula [1-1] and more preferably Formula [1-2]). Examples of the vinyl-polymerizable (radical-polymerizable, cationic-polymerizable, or anionic-polymerizable) monomer containing a crosslinking group that can be introduced in this way are shown below. Note that the vinyl-polymerizable monomer containing various crosslinking groups is not limited to this. In addition, it is also possible to employ a method in which an active group such as an active hydrogen group or an isocyanate group in the vinyl-polymerizable monomer is stabilized with a protective group and copolymerized, and then activated by removing the protective group.

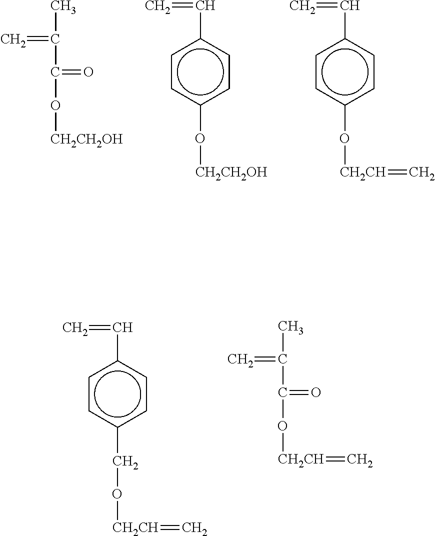

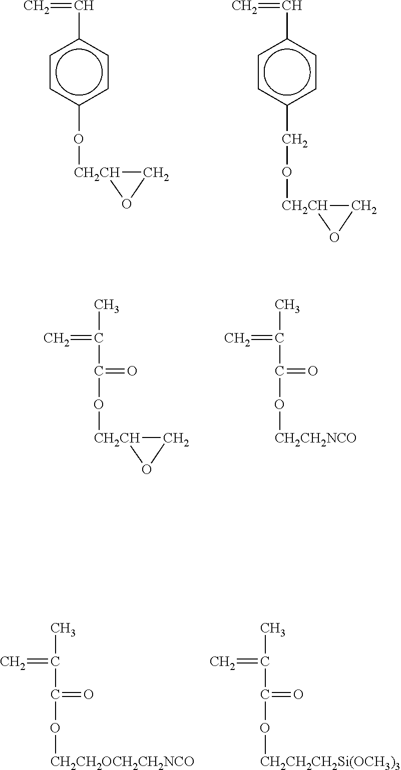

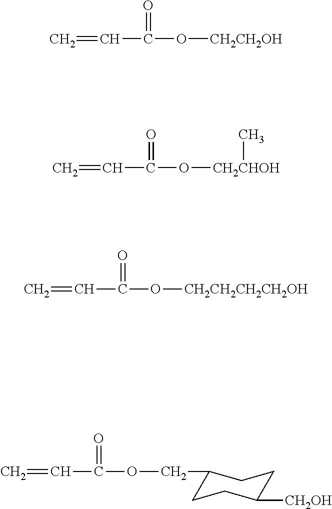

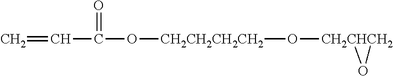

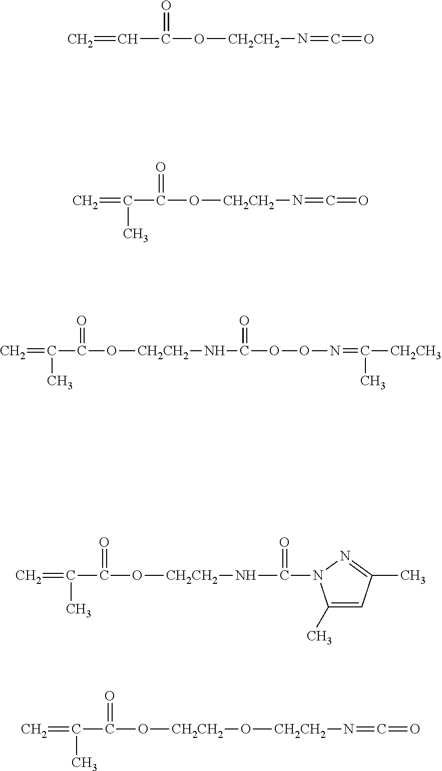

The content of the crosslinking group-containing repeating unit in the crosslinking group-containing fluorine-containing polystyrene derivative is 1 mass % or more and 95 mass % or less. The content of the crosslinking group-containing repeating unit in the crosslinking group-containing fluorine-containing polystyrene derivative is preferably selected from a range of 1 mass % or more and 80 mass % or less, a range of 1 mass % or more and 60 mass % or less, or a range of 1 mass % or more and 50 mass % or less. The crosslinking group-containing repeating unit in the crosslinking group-containing fluorine-containing polystyrene derivative may be one kind or a plurality of kinds.

The crosslinking group-containing fluorine-containing polystyrene derivative may contain one or a plurality of kinds of repeating units of various structures to adjust properties of a crosslinked substance formed by crosslinking at least a part of the crosslinking group of the crosslinking group-containing fluorine-containing polystyrene derivative, in addition to the repeating unit represented by Formula [1], Formula [1-1], or Formula [1-2] and the crosslinking group-containing repeating unit.

For example, as a repeating unit other than the repeating unit represented by Formula [1], Formula [1-1], or Formula [1-2] and the crosslinking group-containing repeating unit, the crosslinking group-containing fluorine-containing polystyrene derivative may contain one or a plurality of kinds of various monomer units which are radical-polymerizable, cationic-polymerizable, or anionic-polymerizable. Specific examples of the polymerizable monomer include various polymerizable monomers such as various substituted styrenes such as α-methylstyrene, p-methylstyrene, p-alkoxystyrene, p-acetoxystyrene, and p-hydroxystyrene (to be synthesized using a deprotection reaction), unsubstituted styrene, vinylnaphthalene, acenaphthylene, maleic anhydride or derivatives thereof, maleimide derivatives, (meth)acrylonitrile, (meth)acrylamide and derivatives thereof, various (meth)acrylates, fluorine-containing (meth)acrylates, various fluorine-containing olefins, various vinyl carboxylates, or various vinyl ethers.

In the crosslinking group-containing fluorine-containing polystyrene derivative, the content of the repeating unit other than the repeating unit represented by Formula [1], Formula [1-1], or Formula [1-2] and the crosslinking group-containing repeating unit may be in a range of 0 mass % or more and 90 mass % or less, 0 mass % or more and 60 mass % or less, or 0 mass % or more and 40 mass % or less with respect to the total mass of the crosslinking group-containing fluorine-containing polystyrene derivative.

For example, the following method can be exemplified as a method for manufacturing a crosslinking group-containing polystyrene derivative containing a repeating unit other than the repeating unit represented by Formula [1] and the crosslinking group-containing repeating unit. Note that the method is not limited to this.
(1) A manufacturing method by an addition reaction of an active terminal group-containing perfluoro(poly)ether compound such as CF₂═CF—[OCF₂CF(CF₃)]_{L1}—ORfa₂ (L₁ and Rfa₂ are the same as those in Formula [1-2]) to a phenolic hydroxy group in a copolymer consisting of the p-hydroxystyrene unit, the crosslinking group-containing repeating unit, and various monomer units.
(2) A manufacturing method using copolymerization of a monomer having a structure of CH₂═CY-Ph-[Q-Rf₀]_{z} (Y, Q, Rf₀, and z are the same as those in Formula [1], and Ph is an abbreviation for a phenylene group), a crosslinking group-containing monomer, and various monomers.

As the crosslinking group-containing fluorine-containing polystyrene derivative, polymers having various structures and sequences, which are manufactured by various manufacturing methods, can be used. For example, the crosslinking group-containing fluorine-containing polystyrene derivative can be manufactured by various copolymerization methods such as radical copolymerization, cationic copolymerization, and anionic copolymerization. Furthermore, it is also possible to manufacture a polymer having a desired crosslinking reactivity by converting a reactive group contained in a copolymer manufactured by such copolymerization into another kind of reactive group. In addition, as the crosslinking group-containing fluorine-containing polystyrene derivative, polymers having various structures such as a random copolymer, a block copolymer, a graft copolymer, and a star-shaped polymer can be used.

One or two or more fluorine-based compounds can be used for manufacturing the magnetic recording medium. In one aspect, it is possible to manufacture a magnetic recording medium containing the fluorine-based compound in the portion on the magnetic layer side, by adding the fluorine-based compound as a component of the composition for forming a magnetic layer (so-called magnetic layer intra-addition). The intra-addition is an abbreviation for internal addition. In addition, in one aspect, a coating liquid containing the fluorine-based compound is prepared, and the coating liquid is applied (so-called overcoat) to the surface of the magnetic layer, so that the fluorine-based compound can be present in the portion on the magnetic layer side. From the viewpoint of reducing the value of the fluorine concentration F, it is preferable to manufacture a magnetic recording medium by the magnetic layer intra-addition. The amount of the fluorine-based compound added to the composition for forming a magnetic layer may be, for example, 0.30 parts by mass or more and 3.00 parts by mass or less, 0.30 parts by mass or more and 2.00 parts by mass or less, or 0.50 parts by mass and more and 1.50 parts by mass or less with respect to 100.00 parts by mass of the ferromagnetic powder. Note that the above range is merely an example, and the addition amount can be adjusted according to the type of the fluorine-based compound and the like.

In the magnetic recording medium in which the fluorine-based compound is contained in the magnetic layer by magnetic layer intra-addition, “B” obtained by the following method may be 60% or more and 95% or less.

“B” in the present invention and the present specification is calculated by Equation 1 from an integrated intensity Ftotal of fragments derived from a fluorine-based compound obtained for an entire region in a thickness direction of a cross section of the magnetic layer by line profile analysis of time-of-flight secondary ion mass spectrometry (TOF-SIMS) and an integrated intensity Fupper of fragments derived from a fluorine-based compound obtained for a region from the surface of the magnetic layer to an intermediate thickness in the thickness direction of the cross section.

As a pretreatment for performing the line profile analysis of TOF-SIMS, an obliquely cut surface including a cross section of the magnetic layer of the magnetic recording medium is formed. The obliquely cut surface is formed by cutting a cutting edge of a cutting device obliquely from the surface of the magnetic layer of the magnetic recording medium to at least a part of a portion (a non-magnetic layer in a case where the magnetic recording medium has a non-magnetic layer, and a non-magnetic support in a case where the magnetic layer is provided directly on the non-magnetic support) adjacent to the magnetic layer. The obliquely cut surface thus formed includes a cross section of the magnetic layer and a cross section of at least a part of a portion adjacent to the magnetic layer. The oblique cutting is performed such that a portion adjacent to the magnetic layer is exposed so that a portion adjacent to the magnetic layer can be analyzed in a region having a length of 100 μm or more in the line profile analysis. A penetration angle of the cutting edge into the surface of the magnetic layer of the magnetic recording medium may be, for example, in a range of 0.010 to 0.200 degrees. In Examples described below, the oblique cutting was performed by setting the penetration angle of the cutting edge into the surface of the magnetic layer of the magnetic recording medium to 0.115 degrees. As the cutting device, for example, an oblique cutting device called SAICAS (registered trademark) can be used. SAICAS is an abbreviation for surface and international cutting analysis system, the SAICAS device may be, for example, a SAICAS device manufactured by Daipla Wintes Co., Ltd. and this device was used in Examples described below.

The line profile analysis of TOF-SIMS is performed on a continuous region extending from a region having a length of 100 μm on a surface (uncut portion) of the magnetic layer to the obliquely cut surface. As the TOF-SIMS device, for example, a TOF-SIMS device manufactured by ION-TOF or ULVAC-PHI, Inc. can be used. Regarding the measurement conditions, an ion beam diameter is set to 5 μm. The measurement mode of the TOF-SIMS includes a high mass resolution mode and a high spatial resolution mode. Here, as the measurement mode, a high mass resolution mode (also referred to as a bunching mode), which is a measurement mode in which a primary ion beam is bunched to perform measurement at a high mass resolution, is adopted. The line profile analysis is performed by setting an interval between measurement points to 2 μm.

Among various fragments obtained as analysis results of the line profile analysis of TOF-SIMS, a fluorine-based fragment for obtaining “B” is determined as follows. In a case where only one fluorine-based fragment is detected in the line profile analysis of TOF-SIMS in the region having a length of 100 μm on the surface (uncut portion) of the magnetic layer, the detected fluorine-based fragment is adopted as a fluorine-based fragment for obtaining “B”.

On the other hand, in a case where a plurality of fluorine-based fragments are detected in the line profile analysis of TOF-SIMS in the region having a length of 100 μm on the surface (uncut portion) of the magnetic layer, a fluorine-based fragment detected with the highest sensitivity is adopted as a fluorine-based fragment for obtaining “B”. For example, in Examples described below, a C₃OF₇₋ fragment was adopted as a fluorine-based fragment for obtaining “B”. In addition, in order to specify the region of the cross section of the magnetic layer from the region where the line profile analysis is performed, one component is selected from among components contained in a portion adjacent to the magnetic layer, and a fragment in which the selected component can be detected with the highest sensitivity is selected. The selection of such a fragment can be performed based on a well-known technology or the result of a preliminary experiment. For example, in Examples described below, phenylphosphonic acid, which is a component of the non-magnetic layer, was selected as the above-described component, and a PO₃₋ fragment was selected as a fragment in which this component can be detected with the highest sensitivity.

An arithmetic average of fragment intensities of the fluorine-based fragments selected above is calculated for the region having a length of 100 μm on the surface (uncut portion) of the magnetic layer. Hereinafter, this arithmetic average will be referred to as [MF]. In addition, an arithmetic average of fragment intensities of the fragments selected above is calculated for a region having a length of 100 μm exposed to the obliquely cut surface in a portion adjacent to the magnetic layer. Hereinafter, this arithmetic average will be referred to as [MN]. From the result of the line profile analysis, a position where the fragment intensity of the fluorine-based fragment selected above is ½ times [MF] is specified as a position where oblique cutting is started (hereinafter, referred to as [point M]). In addition, a position where the fragment intensity of the fragment selected above is ½ times [MN] is specified as a position of an interface between the magnetic layer and a portion adjacent to the magnetic layer (hereinafter, referred to as [point K]). A region between the [point M] and the [point M] this specified is specified as the magnetic layer, and an intermediate between the [point M] and the [point K] is specified as an intermediate thickness position (hereinafter, referred to as [point H]). Assuming that a thickness of the magnetic layer is T, the point H can be said to be a position where a depth from the surface of the magnetic layer is “T/2”.

In the result of the line profile analysis, the integrated intensity of the fluorine-based fragment selected above, which is obtained for an entire range from the point M to the point K (that is, an entire range in the thickness direction of the cross section of the magnetic layer), is defined as “Ftotal”. In addition, in the result of the line profile analysis, the integrated intensity of the fluorine-based fragment selected above, which is obtained for an entire range from the point M to the point H (that is, a region from the magnetic layer surface to the intermediate thickness in the thickness direction of the cross section of the magnetic layer), is defined as “Fupper”. B is calculated by Equation 1 from the Ftotal and the Fupper thus obtained. The arithmetic average of the values of B obtained by forming the obliquely cut surface and performing the line profile analysis of TOF-SIMS at three randomly selected portions of the magnetic recording medium to be measured is defined as a value of B of the magnetic recording medium to be measured.

B=(Fupper/Ftotal)×100 Equation 1

The magnetic layer described above can be provided on a surface of the non-magnetic support directly or indirectly through the non-magnetic layer.

### Non-Magnetic Layer

The magnetic recording medium may include a magnetic layer on the non-magnetic support surface directly, or may include a non-magnetic layer containing non-magnetic powder between the non-magnetic support and the magnetic layer. The non-magnetic powder contained in the non-magnetic layer may be an inorganic powder or an organic powder. In addition, carbon black and the like can be used. Examples of the inorganic powder include powders of metal, metal oxide, metal carbonate, metal sulfate, metal nitride, metal carbide, and metal sulfide. These non-magnetic powders can be available as a commercially available product or can be manufactured by a well-known method. For details thereof, descriptions disclosed in paragraphs 0036 to 0039 of JP2010-24113A can be referred to. The content (filling percentage) of the non-magnetic powder of the non-magnetic layer is preferably in a range of 50 to 90 mass % and more preferably in a range of 60 to 90 mass %, with respect to the total mass of the non-magnetic layer.

The non-magnetic layer contains a non-magnetic powder and can also contain a binding agent together with the non-magnetic powder. For other details of the binding agent or the additive of the non-magnetic layer, a well-known technology regarding the non-magnetic layer can be applied. In addition, in regards to the type and the content of the binding agent, and the type and the content of the additive, for example, the well-known technology regarding the magnetic layer can be applied.

The non-magnetic layer of the magnetic recording medium also includes a substantially non-magnetic layer including a small amount of ferromagnetic powder as impurities or intentionally, together with the non-magnetic powder. Here, the substantially non-magnetic layer is a layer having a residual magnetic flux density equal to or smaller than 10 mT, a layer having a coercivity equal to or smaller than 7.96 kA/m (100 Oe), or a layer having a residual magnetic flux density equal to or smaller than 10 mT and a coercivity equal to or smaller than 7.96 kA/m (100 Oe). It is preferable that the non-magnetic layer does not have a residual magnetic flux density and coercivity.

### Back Coating Layer

The magnetic recording medium can also include a back coating layer containing a non-magnetic powder on a surface side of the non-magnetic support opposite to the surface side on which the magnetic layer is provided. Alternatively, the magnetic recording medium may be a magnetic recording medium having no back coating layer. The back coating layer can contain one or both of carbon black and an inorganic powder.

The back coating layer can include a non-magnetic powder, can include a binding agent, and can also include one or more kinds of additives. In regards to the binding agent and the additive of the back coating layer, a well-known technology regarding the back coating layer can be applied, and a well-known technology regarding the formulation of components of the magnetic layer and/or the non-magnetic layer can be applied. For example, for the back coating layer, descriptions disclosed in paragraphs 0018 to 0020 of JP2006-331625A and page 4, line 65, to page 5, line 38, of U.S. Pat. No. 7,029,774B can be referred to.

### Non-Magnetic Support

Next, the non-magnetic support will be described. Examples of the non-magnetic support (hereinafter, simply referred to as a “support”) include well-known components such as polyethylene terephthalate, polyethylene naphthalate, polyamide such as aromatic polyamide, and polyamideimide subjected to biaxial stretching. Among these, polyethylene terephthalate, polyethylene naphthalate, and polyamide are preferable. A corona discharge, a plasma treatment, an easy-bonding treatment, or a heat treatment may be performed on these supports in advance.

In one aspect, the support included in the magnetic recording medium may be a polyamide support. In the present invention and the present specification, the term “polyamide” means a resin including a plurality of amide bonds. The polyamide can be an aromatic polyamide. The term “aromatic polyamide” means a resin including an aromatic skeleton and a plurality of amide bonds. An aromatic ring contained in the aromatic skeleton of the aromatic polyamide is not particularly limited. Specific examples of the aromatic ring include a benzene ring. The term “polyamide support” means a support including at least one layer of polyamide film. The term “polyamide film” refers to a film in which a component that occupies the largest amount on a mass basis among components constituting the film is polyamide. The term “polyamide support” in the present invention and the present specification includes those in which all resin films included in the support are polyamide films, and those including the polyamide film and another resin film. Specific aspects of the polyamide support include a single-layer polyamide film, a laminated film of two or more polyamide films having the same constituent components, a laminated film of two or more polyamide films having different constituent components, a laminated film including one or more polyamide films and one or more resin films other than the polyamide film, and the like. An adhesive layer or the like may be optionally included between two adjacent layers in the laminated film. The polyamide support may optionally include a metal film and/or a metal oxide film formed on one or both surfaces by vapor deposition or the like. In regard to the term “aromatic polyamide support” in the present invention and the present specification, the polyamide is replaced with an aromatic polyamide and the polyamide film is replaced with an aromatic polyamide film in the above description regarding the polyamide support.

### Various Thicknesses

The total thickness of the magnetic recording medium is preferably 5.6 μm or less, more preferably 5.5 μm or less, still more preferably 5.4 μm or less, still more preferably 5.3 m or less, still more preferably 5.2 μm or less, still more preferably 5.0 μm or less, and still more preferably 4.8 μm or less. It has been required to increase the recording capacity (increase the capacity) of the magnetic recording medium with the enormous increase in the amount of information in recent years. For example, as means for increasing the capacity of a tape-shaped magnetic recording medium (that is, a magnetic tape), a thickness of the magnetic tape may be reduced to increase a length of the magnetic tape accommodated in one roll of a magnetic tape cartridge.

In addition, from the viewpoint of ease of handling, the total thickness of the magnetic recording medium is preferably 3.0 μm or more, more preferably 3.5 μm or more, and still more preferably 4.0 μm or more.

For example, the total thickness of the magnetic tape can be measured by the following method.

Ten samples (for example, 5 to 10 cm in length) are cut out from any part of the magnetic tape, and these samples are stacked to measure the thickness. A value (thickness per sample) obtained by dividing the measured thickness by 1/10 is set as the total thickness. The thickness measurement can be performed using a well-known measuring instrument capable of measuring a thickness on the order of 0.1 μm.

A thickness of the non-magnetic support is preferably 3.0 to 5.0 μm.

A thickness of the magnetic layer can be optimized according to a saturation magnetization amount of a magnetic head used, a head gap length, a band of a recording signal, and the like, and is generally 0.01 μm to 0.15 μm, and, from the viewpoint of high-density recording, the thickness is preferably 0.02 μm to 0.12 μm and more preferably 0.03 μm to 0.1 m. The magnetic layer need only be at least a single layer, the magnetic layer may be separated into two or more layers having different magnetic properties, and a configuration of a well-known multilayered magnetic layer can be applied as the magnetic layer. A thickness of the magnetic layer in a case where the magnetic layer is separated into two or more layers is a total thickness of the layers.

A thickness of the non-magnetic layer is, for example, 0.1 to 1.5 μm, preferably 0.1 to 1.0 μm, and more preferably 0.1 to 0.7 μm.

A thickness of the back coating layer is preferably 0.9 μm or less and more preferably 0.1 to 0.7 μm.

Various thicknesses such as the thickness of the magnetic layer and the like can be obtained by the following method.

A cross section of the magnetic recording medium in a thickness direction is exposed by an ion beam, and then the exposed cross section observation is performed using a scanning electron microscope or a transmission electron microscope. Various thicknesses can be obtained as an arithmetic average of thicknesses obtained at two optional points in the cross section observation. Alternatively, the various thicknesses can be obtained as a designed thickness calculated according to manufacturing conditions.

### Manufacturing Step

A composition for forming the magnetic layer, the non-magnetic layer, and the back coating layer usually contains a solvent together with the various components described above. As the solvent, one kind or two or more kinds of various organic solvents generally used for manufacturing a coating type magnetic recording medium can be used. Specifically, a ketone-based solvent such as acetone, methyl ethyl ketone, methyl isobutyl ketone, diisobutyl ketone, cyclohexanone, isophorone, and tetrahydrofuran, an alcohol-based solvent such as methanol, ethanol, propanol, butanol, isobutyl alcohol, isopropyl alcohol, and methyl cyclohexanol, an ester-based solvent such as methyl acetate, butyl acetate, isobutyl acetate, isopropyl acetate, ethyl lactate, and glycol acetate, a glycol ether solvent such as glycol dimethyl ether, glycol monoethyl ether, and dioxane, an aromatic hydrocarbon solvent such as benzene, toluene, xylene, cresol, and chlorobenzene, a chlorinated hydrocarbon solvent such as methylene chloride, ethylene chloride, carbon tetrachloride, chloroform, ethylene chlorohydrin, and dichlorobenzene, N,N-dimethylformamide, hexane, and the like can be used in an arbitrary ratio. Among these, from the viewpoint of solubility of a binding agent usually used for a coating type magnetic recording medium, it is preferable that the composition for forming a magnetic layer contains one or more kinds of ketone-based solvents. The amount of the solvent in the composition for forming each layer is not particularly limited, and can be set to the same as that of the composition for forming each layer of a typical coating type magnetic recording medium.

A step of preparing the composition for forming each layer can usually include at least a kneading step, a dispersing step, and a mixing step provided before and after these steps, as necessary. Each step may be divided into two or more stages. Various components used in the preparation of the composition for forming each layer may be added at the beginning or during any step. In addition, each component may be separately added in two or more steps.

In order to prepare a composition for forming each layer, a well-known technology can be used. In the kneading step, an open kneader, a continuous kneader, a pressure kneader, or a kneader having a strong kneading force such as an extruder is preferably used. Details of the kneading treatment are described in JP1989-106338A (JP-H01-106338A) and JP1989-79274A (JP-H01-79274A). In addition, in order to disperse the composition for forming each layer, one or more kinds of dispersion beads selected from the group consisting of glass beads and other dispersion beads can be used as a dispersion medium. As such dispersion beads, zirconia beads, titania beads, and steel beads which are dispersion beads having a high specific gravity are suitable. These dispersion beads may be used by optimizing a particle diameter (bead diameter) and a filling percentage of the dispersion beads. As a dispersing device, a well-known dispersing device can be used. The composition for forming each layer may be filtered by a well-known method before performing the coating step. The filtering can be performed by using a filter, for example. As the filter used in the filtering, a filter having a pore diameter of 0.01 to 3 μm (for example, a filter made of glass fiber or a filter made of polypropylene) can be used, for example.

The magnetic layer can be formed, for example, by directly applying the composition for forming a magnetic layer onto the non-magnetic support or performing multilayer applying of the composition for forming a magnetic layer with the composition for forming a non-magnetic layer sequentially or simultaneously. The back coating layer can be formed by applying a composition for forming a back coating layer onto a side of the non-magnetic support opposite to a side having the magnetic layer (or to be provided with the magnetic layer). For details of the coating for forming each layer, a description disclosed in a paragraph 0051 of JP2010-24113A can be referred to.

After the coating step, various treatments such as a drying treatment, an alignment treatment of the magnetic layer, and a surface smoothing treatment (calendering treatment) can be performed. For various steps, for example, a well-known technology disclosed in paragraphs 0052 to 0057 of JP2010-24113A can be referred to.

For example, the coating layer of the composition for forming a magnetic layer can be subjected to an alignment treatment, while the coating layer is in an undried state. For the alignment treatment, various well-known technologies including a description disclosed in a paragraph 0067 of JP2010-231843A can be used. For example, a vertical alignment treatment can be performed by a well-known method such as a method using a polar opposing magnet. In an alignment zone, a drying speed of the coating layer can be controlled depending on a temperature, an air volume of drying air and/or a transportation speed of the non-magnetic support on which the coating layer is formed in the alignment zone. Further, the coating layer may be preliminarily dried before the transportation to the alignment zone. As the alignment condition is strengthened, a value of a square ratio of the magnetic recording medium tends to increase. The square ratio of the magnetic recording medium can be controlled by the presence or absence of the alignment treatment, the alignment condition of the alignment treatment, and the like. Examples of the alignment condition include the strength of the magnet used for the alignment treatment and the magnetic field application time.

For the calendering treatment, in a case where the calendering condition is strengthened, the surface of the magnetic layer of the magnetic recording medium tends to become smoother. The calendering conditions include a calender pressure, a calender temperature (surface temperature of the calender roll), a calender speed, the hardness of the calender roll, and the like, as values of the calender pressure, the calender temperature, and the hardness of the calender roll are increased, the calender process is reinforced, and as the calender speed is low, the calendering treatment is reinforced. For example, the calender pressure (linear pressure) can be 200 to 500 kN/m and is preferably 250 to 350 kN/m. The calender temperature (surface temperature of the calender roll) may be, for example, 85° C. to 120° C., preferably 90° C. to 110° C., and more preferably 95° C. to 110° C. The calender speed may be, for example, 50 to 300 m/min and preferably 50 to 200 m/min.

### Vertical Squareness Ratio

In one aspect, the vertical squareness ratio of the magnetic recording medium may be 0.60 or more, preferably 0.63 or more, and more preferably 0.65 or more. In principle, the maximum value of the vertical squareness ratio is 1.00. Therefore, the vertical squareness ratio of the magnetic recording medium may be 1.00 or less, 0.95 or less, 0.90 or less, 0.85 or less, 0.80 or less, 0.75 or less, or 0.70 or less. From the viewpoint of improving the electromagnetic conversion characteristics, a large value of the vertical squareness ratio is preferable.

In the present invention and the present specification, the vertical squareness ratio of the magnetic recording medium is a squareness ratio measured in the vertical direction of the magnetic recording medium. The vertical direction is a direction orthogonal to the surface of the magnetic recording medium, and can also be referred to as a thickness direction. The vertical squareness ratio is obtained from a vertical M-H curve.

The vertical squareness ratio is obtained by measurement performed by sweeping an external magnetic field to the magnetic recording medium in a range of a magnetic field intensity of −1197 kA/m to 1197 kA/m in a vibrating sample magnetometer. Regarding the magnetic field intensity, a conversion coefficient of unit Oe (Oersted) into SI unit A/m is 10³/4π. The range of −1197 kA/m to 1197 kA/m is synonymous with a range of −15 kOe to 15 kOe. In the present invention and the present specification, the measurement performed using a vibrating sample magnetometer is performed at a measurement temperature of 24° C.±1° C. The external magnetic field is swept by using a measurement sample cut out from the magnetic recording medium to be measured, according to the sweeping conditions shown in Table 5 described below, with the average number in each step=1. By sweeping the external magnetic field in this way, a hysteresis curve (referred to as “M-H curve”) is obtained in the range of magnetic field intensity of −1197 kA/m to 1197 kA/m. The M-H curve obtained by the measurement performed by disposing the measurement sample on a vibrating sample magnetometer such that an application direction of the external magnetic field and a surface of the measurement sample are orthogonal to each other is referred to as a “vertical M-H curve”. The above-described “orthogonal” includes a range of errors allowed in the technical field to which the present invention belongs. The range of the errors means, for example, a range of less than exact orthogonality±10°, and is preferably within the exact orthogonality±5°, and more preferably within the exact orthogonality±3°. The measured value is obtained as a value obtained by subtracting magnetization of a sample probe of a vibrating sample magnetometer as background noise. The square ratio is a square ratio without demagnetic field correction. As a vibrating sample magnetometer (VSM), a well-known device such as the device used in Examples described below can be used. The measurement sample need only have a saturation magnetization obtained from the M-H curve thus obtained in a range of 5×10⁻⁶ to 10×10⁻⁶ A·m² (5×10⁻³ to 10×10⁻³ emu), and the size and shape are not limited as long as the saturation magnetization in this range is obtained.

### Arithmetic Average Roughness Ra of Surface of Magnetic Layer

As an indicator of smoothness of the magnetic layer surface, an arithmetic average roughness Ra of the surface of the magnetic layer can be used.

The smoother the surface of the magnetic layer, the more the deterioration in electromagnetic conversion characteristics due to a spacing loss can be suppressed. From this point, the arithmetic average roughness Ra of the surface of the magnetic layer is preferably 2.20 nm or less, more preferably 2.00 nm or less, and still more preferably 1.80 nm or less. The arithmetic average roughness Ra of the surface of the magnetic layer may be, for example, 1.30 nm or more.

The arithmetic average roughness Ra of the surface of the magnetic layer in the present invention and the present specification is a value measured with an atomic force microscope (AFM) in a region of an area of 40 μm×40 μm on the surface of the magnetic layer. The measurement is performed 5 times at each of three different measurement points which are randomly selected. From measurement results obtained at the three measurement points, an arithmetic average of measured values excluding a minimum value and a maximum value from Ra's obtained by the measurement performed at each measurement point 5 times (that is, three measured values of one measurement point, nine measured values in a total of the three measurement points) is adopted as Ra of the surface of the magnetic layer of the magnetic recording medium to be measured. The arithmetic average roughness Ra of the surface of the magnetic layer described in the section of Examples described below is a value obtained by measurement under the following measurement conditions.

A region of an area of 40 μm×40 μm on the surface of the magnetic layer of the magnetic recording medium is measured with the AFM (Nanoscope 4 manufactured by Veeco Instruments, Inc.) in a tapping mode. RTESP-300 manufactured by BRUKER is used as a probe, a scan speed (probe movement speed) is set to a speed at which one screen (512 pixel×512 pixel) is measured in 341 seconds.

The magnetic recording medium according to one aspect of the present invention may be a tape-shaped magnetic recording medium (magnetic tape) or a disk-shaped magnetic recording medium (magnetic disk). For example, the magnetic tape is accommodated in, for example, a magnetic tape cartridge and the magnetic tape cartridge is mounted on a magnetic recording and reproducing device. A servo pattern can also be formed on the magnetic recording medium by a well-known method in order to enable head tracking in the magnetic recording and reproducing device. The term “formation of servo pattern” can also be referred to as “recording of servo signal”. Hereinafter, the formation of the servo patterns will be described using a magnetic tape as an example.

The servo pattern is usually formed along a longitudinal direction of the magnetic tape. Examples of control (servo control) systems using a servo signal include a timing-based servo (TBS), an amplitude servo, and a frequency servo.

As shown in a European computer manufacturers association (ECMA)-319 (June 2001), a magnetic tape conforming to a linear tape-open (LTO) specification (generally called “LTO tape”) employs a timing-based servo system. In this timing-based servo system, the servo pattern is formed by continuously arranging a plurality of pairs of non-parallel magnetic stripes (also referred to as “servo stripes”) in the longitudinal direction of the magnetic tape. As described above, the reason why the servo pattern is formed of a pair of non-parallel magnetic stripes is to indicate, to a servo signal reading element passing over the servo pattern, a passing position thereof. Specifically, the pair of magnetic stripes is formed such that an interval thereof continuously changes along a width direction of the magnetic tape, and the servo signal reading element reads the interval to thereby sense a relative position between the servo pattern and the servo signal reading element. Information on this relative position enables tracking on a data track. Accordingly, a plurality of servo tracks are usually set on the servo pattern along the width direction of the magnetic tape.

A servo band is formed of a servo signal continuous in the longitudinal direction of the magnetic tape. A plurality of the servo bands are usually provided on the magnetic tape. For example, in an LTO tape, the number of the servo bands is five. Regions interposed between two adjacent servo bands are referred to as data bands. The data band is formed of a plurality of data tracks and each data track corresponds to each servo track.

Further, in one aspect, as shown in JP2004-318983A, information indicating a servo band number (referred to as “servo band identification (ID)” or “unique data band identification method (UDIM) information”) is embedded in each servo band. This servo band ID is recorded by shifting a specific one of the plurality of pairs of the servo stripes in the servo band so that positions thereof are relatively displaced in the longitudinal direction of the magnetic tape. Specifically, a way of shifting the specific one of the plurality of pairs of servo stripes is changed for each servo band. Accordingly, the recorded servo band ID is unique for each servo band, and thus, the servo band can be uniquely specified only by reading one servo band with a servo signal reading element.

As a method of uniquely specifying the servo band, a staggered method as shown in ECMA-319 (June 2001) is used. In this staggered method, a group of pairs of non-parallel magnetic stripes (servo stripes) arranged continuously in plural in a longitudinal direction of the magnetic tape is recorded so as to be shifted in a longitudinal direction of the magnetic tape for each servo band. Since this combination of shifting methods between adjacent servo bands is unique throughout the magnetic tape, it is possible to uniquely specify a servo band in a case of reading a servo pattern with two servo signal reading elements.

As shown in ECMA-319 (June 2001), information indicating a position of the magnetic tape in the longitudinal direction (also referred to as “longitudinal position (LPOS) information”) is usually embedded in each servo band. This LPOS information is also recorded by shifting the positions of the pair of servo stripes in the longitudinal direction of the magnetic tape, as the UDIM information. Note that, unlike the UDIM information, in this LPOS information, the same signal is recorded in each servo band.

It is also possible to embed, in the servo band, the other information different from the above UDIM information and LPOS information. In this case, the embedded information may be different for each servo band as the UDIM information or may be common to all servo bands as the LPOS information.

As a method of embedding information in the servo band, it is possible to employ a method other than the above. For example, a predetermined code may be recorded by thinning out a predetermined pair from the group of pairs of servo stripes.

A head for forming a servo pattern is called a servo write head. The servo write head has a pair of gaps corresponding to the pair of magnetic stripes as many as the number of servo bands. Usually, a core and a coil are connected to each pair of gaps, and by supplying a current pulse to the coil, a magnetic field generated in the core can cause generation of a leakage magnetic field in the pair of gaps. In a case of forming the servo pattern, by inputting a current pulse while running the magnetic tape on the servo write head, the magnetic pattern corresponding to the pair of gaps is transferred to the magnetic tape to form the servo pattern. A width of each gap can be appropriately set according to a density of the servo pattern to be formed. The width of each gap can be set to, for example, 1 μm or less, 1 to 10 μm, 10 μm or more, and the like.

Before the servo pattern is formed on the magnetic tape, the magnetic tape is usually subjected to a demagnetization (erasing) treatment. This erasing treatment can be performed by applying a uniform magnetic field to the magnetic tape using a direct current magnet or an alternating current magnet. The erasing treatment includes direct current (DC) erasing and alternating current (AC) erasing. AC erasing is performed by gradually decreasing an intensity of the magnetic field while reversing a direction of the magnetic field applied to the magnetic tape. On the other hand, DC erasing is performed by applying a unidirectional magnetic field to the magnetic tape. As the DC erasing, there are two additional methods. A first method is horizontal DC erasing of applying a unidirectional magnetic field along a longitudinal direction of the magnetic tape. A second method is vertical DC erasing of applying a unidirectional magnetic field along a thickness direction of the magnetic tape. The erasing treatment may be performed on the entire magnetic tape or may be performed for each servo band of the magnetic tape.

A direction of the magnetic field of the servo pattern to be formed is determined according to a direction of the erasing. For example, in a case where the horizontal DC erasing is performed to the magnetic tape, the servo pattern is formed so that the direction of the magnetic field is opposite to the direction of the erasing. Therefore, an output of a servo signal obtained by reading the servo pattern can be increased. As shown in JP2012-53940A, in a case where the magnetic pattern is transferred to, using the gap, a magnetic tape that has been subjected to the vertical DC erasing, a servo signal obtained by reading the formed servo pattern has a monopolar pulse shape. On the other hand, in a case where a magnetic pattern is transferred to, using the gap, a magnetic tape that has been subjected to horizontal DC erasing, a servo signal obtained by reading the formed servo pattern has a bipolar pulse shape.

### Magnetic Tape Cartridge

Another aspect of the present invention relates to a magnetic tape cartridge including the tape-shaped magnetic recording medium (that is, the magnetic tape).

The details of the magnetic tape included in the above magnetic tape cartridge are as described above.

In the magnetic tape cartridge, generally, the magnetic tape is accommodated inside a cartridge body in a state of being wound around a reel. The reel is rotatably provided inside the cartridge body. As the magnetic tape cartridge, a single reel type magnetic tape cartridge having one reel inside the cartridge body and a dual reel type magnetic tape cartridge having two reels inside the cartridge body are widely used. In a case where the single reel type magnetic tape cartridge is mounted on a magnetic recording and reproducing device for recording and/or reproducing data on the magnetic tape, the magnetic tape is pulled out of the magnetic tape cartridge to be wound around the reel on the magnetic recording and reproducing device side. A magnetic head is disposed on a magnetic tape transportation path from the magnetic tape cartridge to a winding reel. Feeding and winding of the magnetic tape are performed between a reel (supply reel) on the magnetic tape cartridge side and a reel (winding reel) on the magnetic recording and reproducing device side. During this time, data is recorded and/or reproduced as the magnetic head and the surface on the magnetic layer side of the magnetic tape come into contact with each other to be slid on each other. With respect to this, in the dual reel type magnetic tape cartridge, both reels of the supply reel and the winding reel are provided in the magnetic tape cartridge. The magnetic tape cartridge may be any of single reel type magnetic tape cartridge and dual reel type magnetic tape cartridge. The above magnetic tape cartridge need only include the magnetic tape according to one aspect of the present invention, and the well-known technology can be applied to the others.

### Magnetic Recording and Reproducing Device

Still another aspect of the present invention relates to a magnetic recording and reproducing device including the magnetic recording medium.

In the present invention and the present specification, the term “magnetic recording and reproducing device” means a device capable of performing at least one of the recording of data on the magnetic recording medium or the reproducing of data recorded on the magnetic recording medium. Such a device is generally called a drive. The magnetic recording and reproducing device can be, for example, a sliding type magnetic recording and reproducing device. The sliding type magnetic recording and reproducing device is a device in which the surface on the magnetic layer side and the magnetic head come into contact with each other to be slid on each other, in a case of performing recording of data on the magnetic recording medium and/or reproducing of the recorded data. For example, the magnetic recording and reproducing device can attachably and detachably include the magnetic tape cartridge.

The magnetic recording and reproducing device may include a magnetic head. The magnetic head can be a recording head capable of performing the recording of data on the magnetic recording medium, and can also be a reproducing head capable of performing the reproducing of data recorded on the magnetic recording medium. In addition, in one aspect, the magnetic recording and reproducing device can include both a recording head and a reproducing head as separate magnetic heads. In another aspect, the magnetic head included in the magnetic recording and reproducing device can have a configuration in which both an element for recording data (recording element) and an element for reproducing data (reproducing element) are included in one magnetic head. Hereinafter, the element for recording data and the element for reproducing are collectively referred to as “elements for data”. As the reproducing head, a magnetic head (MR head) including a magnetoresistive (MR) element capable of sensitively reading data recorded on the magnetic recording medium as a reproducing element is preferable. As the MR head, various well-known MR heads such as an Anisotropic Magnetoresistive (AMR) head, a Giant Magnetoresistive (GMR) head, or a Tunnel Magnetoresistive (TMR) head can be used. In addition, the magnetic head which performs the recording of data and/or the reproducing of data may include a servo signal reading element. Alternatively, as a head other than the magnetic head which performs the recording of data and/or the reproduction of data, a magnetic head (servo head) comprising a servo signal reading element may be included in the magnetic recording and reproducing device. For example, a magnetic head that records data and/or reproduces recorded data (hereinafter also referred to as “recording and reproducing head”) can include two servo signal reading elements, and the two servo signal reading elements can simultaneously read two adjacent servo bands. One or a plurality of elements for data can be disposed between the two servo signal reading elements.

In the magnetic recording and reproducing device, recording of data on the magnetic recording medium and/or reproducing of data recorded on the magnetic recording medium can be performed, for example, as the surface of the magnetic recording medium on the magnetic layer side and the magnetic head come into contact with each other to be slid on each other. The magnetic recording and reproducing device need only include the magnetic recording medium according to one aspect of the present invention, and a well-known technology can be applied to the others.

For example, in a case of recording data and/or reproducing recorded data, first, tracking using the servo signal is performed. That is, by causing the servo signal reading element to follow a predetermined servo track, the element for data is controlled to pass on the target data track. Displacement of the data track is performed by changing a servo track read by the servo signal reading element in a tape width direction.

The recording and reproducing head can also perform recording and/or reproduction with respect to other data bands. In this case, the servo signal reading element need only be displaced to a predetermined servo band using the above described UDIM information to start tracking for the servo band.

### EXAMPLES

Hereinafter, the present invention will be described in more detail with reference to Examples. Here, the present invention is not limited to embodiments shown in Examples. “Parts” and “%” in the following description mean “parts by mass” and “mass %”, unless otherwise noted. The following steps and evaluations were performed in the atmosphere at a room temperature (20° C. to 25° C.), unless otherwise noted. “eq” in the following description is an equivalent and is a unit that cannot be converted into an SI unit.

### Ferromagnetic Powder

In Table 6, “BaFe” described in a column of “ferromagnetic powder” is a hexagonal barium ferrite powder having an average particle size (average plate diameter) of 21 nm.

In Table 6, “SrFe” described in the column of “ferromagnetic powder” indicates a hexagonal strontium ferrite powder manufactured as follows.

1707 g of SrCO₃, 687 g of H₃BO₃, 1120 g of Fe₂O₃, 45 g of Al(OH)₃, 24 g of BaCO₃, 13 g of CaCO₃, and 235 g of Nd₂O₃ were weighed and mixed by a mixer to obtain a raw material mixture.

The obtained raw material mixture was melted in a platinum crucible at a melting temperature of 1390° C., and a hot water outlet provided at a bottom of the platinum crucible was heated while stirring a melt, and the melt was discharged in a rod shape at about 6 g/sec. Hot water was rolled and quenched by a pair of water-cooling rollers to manufacture an amorphous body.

280 g of the manufactured amorphous body was charged into an electric furnace, was heated to 635° C. (crystallization temperature) at a temperature rising rate of 3.5° C./min, and was kept at the same temperature for 5 hours to precipitate (crystallize) hexagonal strontium ferrite particles.

Next, a crystallized product obtained above and including hexagonal strontium ferrite particles was coarsely pulverized in a mortar, and 1000 g of zirconia beads having a particle diameter of 1 mm and 800 mL of an acetic acid aqueous solution of 1% concentration were added to the crystallized product in a glass bottle containing the pulverized material, to be dispersed by a paint shaker for 3 hours. Thereafter, the obtained dispersion liquid was separated from the beads, to be put in a stainless beaker. The dispersion liquid was statically left at a liquid temperature of 100° C. for 3 hours and subjected to a dissolving treatment of a glass component, and then the crystallized product was sedimented by a centrifugal separator to be washed by repeatedly performing decantation and was dried in a heating furnace at an in-furnace temperature of 110° C. for 6 hours to obtain a hexagonal strontium ferrite powder.

An average particle size of the hexagonal strontium ferrite powder obtained above was 18 nm, an activation volume was 902 nm³, an anisotropy constant Ku was 2.2×10′ J/m³, and a mass magnetization as was 49 A·m²/kg.

12 mg of a sample powder was taken from the hexagonal strontium ferrite powder obtained above, elemental analysis of the filtrated solution obtained by partially dissolving this sample powder under dissolution conditions illustrated above was performed by an ICP analyzer, and a surface layer portion content of a neodymium atom was determined.

Separately, 12 mg of a sample powder was taken from the hexagonal strontium ferrite powder obtained above, elemental analysis of the filtrated solution obtained by totally dissolving this sample powder under dissolution conditions illustrated above was performed by an ICP analyzer, and a bulk content of a neodymium atom was determined.

A content (bulk content) of a neodymium atom with respect to 100 at % of an iron atom in the hexagonal strontium ferrite powder obtained above was 2.9 at %. A surface layer portion content of a neodymium atom was 8.0 at %. It was confirmed that a ratio between a surface layer portion content and a bulk content, that is, “surface layer portion content/bulk content” was 2.8, and a neodymium atom was unevenly distributed in a surface layer of a particle.

The fact that the powder obtained above shows a crystal structure of hexagonal ferrite was confirmed by performing scanning with CuKα rays under conditions of a voltage of 45 kV and an intensity of 40 mA and measuring an X-ray diffraction pattern under the following conditions (X-ray diffraction analysis). The powder obtained above showed a crystal structure of hexagonal ferrite of a magnetoplumbite type (M type). A crystal phase detected by X-ray diffraction analysis was a single phase of a magnetoplumbite type.
PANalytical X'Pert Pro diffractometer, PIXcel detector
Soller slit of incident beam and diffracted beam: 0.017 radians
Fixed angle of dispersion slit: ¼ degrees
Mask: 10 mm
Anti-scattering slit: ¼ degrees
Measurement mode: continuous
Measurement time per stage: 3 seconds
Measurement speed: 0.017 degrees per second
Measurement step: 0.05 degrees

In Table 6, “ε-iron oxide” described in the column of ferromagnetic powder indicates a ε-iron oxide powder manufactured as follows.

8.3 g of iron(III) nitrate nonahydrate, 1.3 g of gallium (III) nitrate octahydrate, 190 mg of cobalt (II) nitrate hexahydrate, 150 mg of titanium(IV) sulfate, and 1.5 g of polyvinylpyrrolidone (PVP) were dissolved in 90 g of pure water, and while the dissolved product was stirred using a magnetic stirrer, 4.0 g of an aqueous ammonia solution having a concentration of 25% was added to the dissolved product under a condition of an atmosphere temperature of 25° C. in an air atmosphere, and the dissolved product was stirred for 2 hours while maintaining a temperature condition of the atmosphere temperature of 25° C. A citric acid aqueous solution obtained by dissolving 1 g of citric acid in 9 g of pure water was added to the obtained solution, and the mixture was stirred for 1 hour. The powder sedimented after stirring was collected by centrifugal separation, was washed with pure water, and was dried in a heating furnace at an in-furnace temperature of 80° C.

800 g of pure water was added to the dried powder, and the powder was dispersed again in water to obtain dispersion liquid. The obtained dispersion liquid was heated to a liquid temperature of 50° C., and 40 g of an aqueous ammonia solution having a concentration of 25% was dropwise added with stirring. After stirring for 1 hour while maintaining the temperature at 50° C., 14 mL of tetraethoxysilane (TEOS) was added dropwise and was stirred for 24 hours. A powder sedimented by adding 50 g of ammonium sulfate to the obtained reaction solution was collected by centrifugal separation, was washed with pure water, and was dried in a heating furnace at an in-furnace temperature of 80° C. for 24 hours to obtain a ferromagnetic powder precursor.

The obtained ferromagnetic powder precursor was loaded into a heating furnace at an in-furnace temperature of 1000° C. in an air atmosphere and was heat-treated for 4 hours.

The heat-treated ferromagnetic powder precursor was put into an aqueous solution of 4 mol/L sodium hydroxide (NaOH), and the liquid temperature was maintained at 70° C. and was stirred for 24 hours, whereby a silicic acid compound as an impurity was removed from the heat-treated ferromagnetic powder precursor.

Thereafter, the ferromagnetic powder from which the silicic acid compound was removed was collected by centrifugal separation, and was washed with pure water to obtain a ferromagnetic powder.

The composition of the obtained ferromagnetic powder that was checked by high-frequency inductively coupled plasma-optical emission spectrometry (ICP-OES) has Ga, Co, and a Ti substitution type ε-iron oxide (ε-Ga_{0.28}Co_{0.05}Ti_{0.05}Fe_{1.62}O₃). In addition, X-ray diffraction analysis is performed under the same condition as that described above for the hexagonal strontium ferrite powder SrFe, and from a peak of an X-ray diffraction pattern, it is checked that the obtained ferromagnetic powder does not include α-phase and γ-phase crystal structures, and has a single-phase and ε-phase crystal structure (s-iron oxide crystal structure).

The obtained ε-iron oxide powder had an average particle size of 12 nm, an activation volume of 746 nm³, an anisotropy constant Ku of 1.2×10⁵ J/m³, and a mass magnetization as of 16 A·m²/kg.

An activation volume and an anisotropy constant Ku of the above hexagonal strontium ferrite powder and ε-iron oxide powder are values obtained by the method described above using a vibrating sample magnetometer (manufactured by Toei Industry Co., Ltd.) for each ferromagnetic powder.

In addition, a mass magnetization as is a value measured at a magnetic field intensity of 1194 kA/m (15 kOe) using a vibrating sample magnetometer (manufactured by Toei Industry Co., Ltd.).

### Example 1

### 1. Preparation of Alumina Dispersion (Abrasive Solution)

3.0 parts of 2,3-dihydroxynaphthalene (manufactured by Tokyo Chemical Industry Co., Ltd.), 31.3 parts of a 32% solution (solvent is a mixed solvent of methyl ethyl ketone and toluene) of a polyester polyurethane resin having a SO₃Na group as a polar group (UR-4800 manufactured by Toyobo Co., Ltd. (amount of a polar group: 80 meq/kg)), and 570.0 parts of a mixed solution of methyl ethyl ketone and cyclohexanone at 1:1 (mass ratio) as a solvent were mixed with respect to 100.0 parts of an alumina powder (HIT-80 manufactured by Sumitomo Chemical Co., Ltd.) having a pregelatinization ratio of about 65% and a (BET) specific surface area of 20 μm²/g, and dispersed in the presence of zirconia beads by a paint shaker for 5 hours. After the dispersion, the dispersion liquid and the beads were separated by a mesh and an alumina dispersion was obtained.

### 2. Formulation of Composition for Forming Magnetic Layer

Magnetic Liquid
Ferromagnetic powder (see Table 6): 100.00 parts
SO₃Na group-containing vinyl chloride copolymer: 10.00 parts Weight-average molecular weight: 70,000, SO₃Na group: 0.2 meq/g
SO₃Na group-containing polyurethane resin: 4.00 parts Weight-average molecular weight: 70,000, SO₃Na group: 0.2 meq/g
Cyclohexanone: 150.00 parts
Methyl ethyl ketone: 170.00 parts
Abrasive Solution
Alumina dispersion prepared in the section 1: 37.40 parts
Other Components
Carbon black: 0.50 parts
   Average particle size: 80 nm
Stearic acid: see Table 6
Stearic acid amide: see Table 6
Butyl stearate: 6.00 parts
Polyisocyanate (CORONATE (registered trademark) manufactured by Tosoh Corporation): 2.50 parts
Fluorine-based compound: see Table 6
Finishing Additive Solvent
Cyclohexanone: 300.00 parts
Methyl ethyl ketone: 140.00 parts

As the fluorine-based compound, a crosslinking group-containing fluorine-containing polystyrene derivative containing a repeating unit represented by Formula [1-2] in a range of 1 mass % or more and 99 mass % or less and a crosslinking group-containing repeating unit in a range of 1 mass % or more and 95 mass % or less was used. The crosslinking group-containing repeating unit has an epoxy group as a crosslinking group. Specifically, in the preparation of the magnetic liquid, a commercially available additive (fluororesin additive NEOFLUORIPEL “NFR-325” manufactured by Noda Screen Co., Ltd.) containing the crosslinking group-containing fluorine-containing polystyrene derivative was used in an amount such that the amount of the additive with respect to the ferromagnetic powder of 100.00 parts contained in the composition for forming a magnetic layer was the value shown in Table 6.

### 3. Formulation of Composition for Forming Non-Magnetic Layer

Non-magnetic inorganic powder (α-iron oxide): 100.00 parts
   Average particle size (average long axis length): 0.15 μm, average acicular ratio: 7, BET specific surface area: 52 μm²/g
Carbon black: 30.00 parts
   Average particle size: 20 nm
SO₃Na group-containing vinyl chloride copolymer: 20.00 parts
   Weight-average molecular weight: 70,000, SO₃Na group: 0.2 meq/g
SO₃Na group-containing polyurethane resin: 100.00 parts
   Weight-average molecular weight: 70,000, SO₃Na group: 0.2 meq/g
Trioctylamine: 1.00 part
Phenylphosphonic acid: 4.00 parts
Stearic acid: see Table 6
Stearic acid amide: see Table 6
Butyl stearate: 3.00 parts
Cyclohexanone: 450.00 parts
Methyl ethyl ketone: 450.00 parts

### 4. Formulation of Composition for Forming Back Coating Layer

Carbon black: 100.00 parts
   Average particle size: 40 nm, and dibutyl phthalate (DBP) oil absorption amount: 74 cm³/100 g
Copper phthalocyanine: 3.00 parts
Nitrocellulose: 25.00 parts
Sulfonic acid group-containing polyester polyurethane resin (UR-8401 manufactured by Toyobo Co., Ltd.): 60.00 parts
Polyester resin (VYLON 500 manufactured by Toyobo Co., Ltd.): 4.00 parts
Alumina powder (α-alumina having a BET specific surface area of 21 μm²/g): 1.00 part
Polyisocyanate (CORONATE L manufactured by Nippon Polyurethane Co., Ltd.): 15.00 parts
Methyl ethyl ketone: 600.00 parts
Toluene: 600.00 parts

### 5. Preparation of Composition for Forming Each Layer

The composition for forming a magnetic layer was prepared by the following method.

The magnetic liquid was prepared by mixing various components of the magnetic liquid with a homogenizer and then dispersing the beads with zirconia beads having a bead diameter of 0.05 mm by a continuous horizontal beads mill for 10 minutes.

Using the beads mill, the above magnetic liquid was mixed with the above abrasive solution, the above other components, and the finishing additive solvent, and then treated (ultrasonically dispersed) using a batch type ultrasonic device (20 kHz, 300 W) for 0.5 minutes. Thereafter, filtration was performed using a filter having a pore diameter of 0.5 μm to prepare a composition for forming a magnetic layer.

A composition for forming a non-magnetic layer was prepared by the following method.

Various components excluding stearic acid, stearic acid amide, butyl stearate were dispersed by using a batch type vertical sand mill for 12 hours to obtain a dispersion liquid. As dispersion beads, zirconia beads having a bead diameter of 0.1 mm were used. Thereafter, the remaining components were added to the obtained dispersion liquid, and the mixture was stirred by a disper. The obtained dispersion liquid thus obtained was filtered using a filter having a pore diameter of 0.5 μm to prepare a composition for forming a non-magnetic layer.

A composition for forming a back coating layer was prepared by the following method.

The above components excluding polyisocyanate were introduced into a dissolver stirrer, stirred at a circumferential speed of 10 m/sec for 30 minutes, and then subjected to a dispersion treatment by a horizontal beads mill disperser. After that, polyisocyanate was added, and stirred and mixed by a dissolver stirrer, and a composition for forming a back coating layer was prepared.

### 6. Manufacture of Magnetic Tape

The composition for forming a non-magnetic layer was applied onto a surface of an aromatic polyamide support having a thickness of 3.6 μm and was dried so that the thickness after drying was 0.7 μm, and thus a non-magnetic layer was formed.

The composition for forming a magnetic layer was applied onto the formed non-magnetic layer so that the thickness after drying is 0.04 μm, and thus a coating layer was formed. No alignment was performed in a magnetic field.

After the coating layer was dried, the composition for forming a back coating layer was applied onto the surface of the aramid support on a side opposite to the surface of the aromatic polyamide support on which the non-magnetic layer and the magnetic layer were formed, and was dried, so that the thickness after the drying is 0.3 μm.

After that, a surface smoothing treatment (calendering treatment) was performed by using a calender roll configured of only a metal roll, at a speed of 100 m/min, a linear pressure of 300 kg/cm (294 kN/m), and a calender temperature (surface temperature of calender roll) of 100° C.

After that, a heat treatment was performed for 36 hours in an environment of an atmosphere temperature of 70° C., and then a slit was made to a width of ½ inches (0.0127 meters) to obtain a magnetic tape.

A thickness of each layer is a design thickness calculated from the manufacturing conditions.

### Examples 2 to 5, 8, and 9 and Comparative Examples 1 to 5

A magnetic tape was manufactured by the method described for Example 1 except that the items shown in Table 6 were changed as shown in Table 6.

### Example 6

A magnetic tape was manufactured by the method described in Example 1 except that, after the composition for forming a magnetic layer was applied to form a coating layer, a magnetic field having a magnetic field intensity of 0.4 T was applied in a vertical direction with respect to the surface of the coating layer while the coating layer is in an undried state, to perform a vertical alignment treatment, and then the coating layer was dried.

### Example 7

A magnetic tape was manufactured by the method described in Example 1 except that an aromatic polyamide support having a thickness of 3.0 μm was used.

### Comparative Example 6

A magnetic tape was manufactured by the method described in Example 1 except for the following points.

A commercially available additive (fluororesin additive NEOFLUORIPEL “NFR-325” manufactured by Noda Screen Co., Ltd.) containing the crosslinking group-containing fluorine-containing polystyrene derivative was not added to the composition for forming a magnetic layer, but was applied (that is, overcoated) onto the magnetic layer surface after the calendering treatment using a wire bar and dried. The amount of the additive applied by the overcoat was 1.00 part with respect to 100.00 parts by mass of the ferromagnetic powder contained in the composition for forming a magnetic layer. After that, a heat treatment was performed for 36 hours in an environment of an atmosphere temperature of 70° C., and then a slit was made to a width of ½ inches (0.0127 meters) to obtain a magnetic tape.

### Evaluation Method of Physical Properties

### (1) Fluorine Concentration F and ΔC

The fluorine concentration F and the ΔC were obtained for each of the magnetic tapes of Examples and Comparative Examples by the method described above, specifically, the following method.

Two sample pieces were cut out from each of the magnetic tapes of Examples and Comparative Examples. One sample piece was not subjected to the methanol extraction treatment, and the other sample piece was subjected to the methanol extraction treatment and then subjected to X-ray photoelectron spectroscopy on the magnetic layer surface (measurement region: 300 μm×700 μm) by the following method using an ESCA device.

### Methanol Extraction Treatment

About 30 mL of methanol (a special grade reagent manufactured by Fujifilm Wako Pure Chemical Corporation) was put in a 100 mL beaker, and the entire sample piece cut out to have a length of 5 cm from the magnetic tape (width of ½ inches) manufactured above was immersed therein. The beaker was placed on a hot plate whose set temperature was set to 60° C. and heated for 3 hours. After that, the sample piece was taken out from the methanol, and in order to clean the sample surface, the sample piece was placed in a 100 mL beaker containing about 30 mL of normal hexane (a special grade reagent manufactured by Fujifilm Wako Pure Chemical Co., Ltd.), and the entire sample piece was allowed to stand for 30 minutes at room temperature in a state of being immersed in normal hexane. After that, the sample piece was taken out from the normal hexane and dried at the room temperature for 1 day or more.

### Analysis and Calculation Method

The following measurements (i) and (ii) were all performed under the measurement conditions shown in Table 1.

TABLE 1

| | |
|---|---|
| Apparatus | AXIS-ULTRA manufactured by |
| | Shimadzu Corporation |
| Excitation X-ray source | Monochromatic Al-Kα ray |
| | (output: 15 kV, 15 mA) |
| Analyzer mode | Spectrum |
| Lens mode | Hybrid (Analysis area: |
| | 300 μm × 700 μm) |
| Neutralization electron | On (use) |
| gun for charge correction | |
| (charge neutralizer) | |
| Photoelectron take-off | 10 degrees (angle of detector |
| angle | and sample surface) |

### (i) Wide Scan Measurement

Wide scan measurement (measurement conditions: see Table 2) was performed regarding the magnetic layer surface of the sample piece with the ESCA device, and the types of the detected elements were researched (qualitative analysis).

TABLE 2

| | | Energy | Take-in | Accumulation |
|---|---|---|---|---|
| | Pass | resolution | time | number |
| Scan range | energy | (Step) | (dwell) | (sweeps) |
| 0 to 1200 eV | 160 eV | 1 eV/step | 100 ms/step | 5 |

### (ii) Narrow Scan Measurement

Narrow scan measurement (measurement conditions: see Table 3) was performed on all the elements detected in the section (i). An atomic concentration (unit: at %) of each element detected from the peak area of each element was calculated using data processing software (Vision 2.2.6) attached to the device. Here, the fluorine concentration was calculated for the sample piece without the methanol extraction treatment. For each of the sample piece without the methanol extraction treatment and the sample piece after the methanol extraction treatment, the C—H derived carbon concentration was calculated by further performing peak separation by a method described below.

TABLE 3

| | | | | Energy | Take-in | Accumulation |
|---|---|---|---|---|---|---|
| | | | Pass | resolution | time | number |
| Spectra¹⁾ | Scan range | | energy | (Step) | (dwell) | (sweeps)²⁾ |
| C1s | 276 to 296 | eV | 80 eV | 0.1 eV/step | 100 ms/step | 3 |
| Cl2p | 190 to 212 | eV | 80 eV | 0.1 eV/step | 100 ms/step | 5 |
| N1s | 390 to 410 | eV | 80 eV | 0.1 eV/step | 100 ms/step | 5 |
| O1s | 521 to 541 | eV | 80 eV | 0.1 eV/step | 100 ms/step | 3 |
| F1s | 685 to 692 | eV | 80 eV | 0.1 eV/step | 100 ms/step | 3 |
| Fe2p | 700 to 740 | eV | 80 eV | 0.1 eV/step | 100 ms/step | 3 |
| Ba3d | 765 to 815 | eV | 80 eV | 0.1 eV/step | 100 ms/step | 3 |
| Al2p | 64 to 84 | eV | 80 eV | 0.1 eV/step | 100 ms/step | 5 |
| Y3d | 148 to 168 | eV | 80 eV | 0.1 eV/step | 100 ms/step | 3 |
| P2p | 120 to 140 | eV | 80 eV | 0.1 eV/step | 100 ms/step | 5 |
| Zr3d | 171 to 191 | eV | 80 eV | 0.1 eV/step | 100 ms/step | 5 |
| Bi4f | 151 to 171 | eV | 80 eV | 0.1 eV/step | 100 ms/step | 3 |
| Sn3d | 477 to 502 | eV | 80 eV | 0.1 eV/step | 100 ms/step | 5 |
| Si2p | 90 to 110 | eV | 80 eV | 0.1 eV/step | 100 ms/step | 5 |
| S2p | 153 to 173 | eV | 80 eV | 0.1 eV/step | 100 ms/step | 5 |

Note¹⁾
Spectra (element type) shown in Table 3 are examples, and in a case where element not shown in Table 3 is detected by qualitative analysis of (i), the same narrow scan measurement is performed in scan range where entire spectra of detected element is included.
Note²⁾
Spectra with favorable signal-to-noise ratio (S/N ratio) were measured with three times of accumulation number. Note that even though accumulation number is five for all spectra, quantitative result is not affected.

(iii) Acquisition of C1s Spectra

The C1s spectra were acquired under the measurement conditions disclosed in Table 4. For the acquired C1s spectra, a shift (physical shift) due to charging of a sample was corrected using data processing software (Vision 2.2.6) attached to the device, and then fitting (peak separation) of the C is spectra was performed using the software. For the peak separation, a Gauss-Lorentz complex function (Gaussian component: 70%, Lorentz component: 30%) was used, and the C1s spectra were fitted by a nonlinear least-squares method to calculate a proportion (peak area ratio) of the C—H peak in the C1s spectra. A C—H derived carbon concentration was calculated by multiplying the calculated C—H peak surface area ratio by the carbon concentration obtained in (ii) above.

TABLE 4

| | | | Energy | Take-in | Accumulation |
|---|---|---|---|---|---|
| | Scan | Pass | resolution | time | number |
| Spectra | range | energy | (Step) | (dwell) | (sweeps) |
| C1s | 276 to 296 eV | 10 eV | 0.1 eV/step | 200 ms/step | 20 |

The above operation was performed three times at different positions on the magnetic layer surface of the sample piece without the methanol extraction treatment. An arithmetic average of the values of the fluorine concentration thus obtained was defined as the fluorine concentration F of the magnetic tape to be measured. In addition, an arithmetic average of the values of the C—H derived carbon concentration thus obtained was defined as the C_{before} of the magnetic tape to be measured.

For the sample piece after the methanol extraction treatment, the above operation was performed three times at different positions on the magnetic layer surface. An arithmetic average of the values of the C—H derived carbon concentration thus obtained was defined as the C_{after} of the magnetic tape to be measured.

From the C_{before} and the C_{after} thus obtained, the ΔC of the magnetic tape to be measured was obtained by Equation: ΔC=C_{before}− C_{after}.

### (2) Measurement of Contact Angle

The contact angle was measured in a measurement environment of an atmosphere temperature of 23° C. and a relative humidity of 50%.

As a contact angle measuring device, “DM700” manufactured by Kyowa Interface Science Co., Ltd. was used. As water, ultrapure water distilled after ion exchange was used. The ultrapure water was put into a syringe, and a Teflon (registered trademark)-coated needle (18 G (gauge)) was attached thereto, and the syringe was set in a contact angle measuring device. 2.5 μL of water was added dropwise onto a measurement point on the magnetic layer surface of the sample piece cut out from each of the magnetic tapes of Examples and Comparative Examples, and the contact angle was measured by a θ/2 method. For each sample piece, the measurement points are set to five points randomly selected on the surface of the magnetic layer, and an arithmetic average of values measured at the five points was taken as the contact angle with water measured on the surface of the magnetic layer of the magnetic tape to be measured.

### (3) Vertical Squareness Ratio

From each of the magnetic tapes of Examples and Comparative Examples, three tape samples having a size of a short side of 12 mm× a long side of 32 mm were cut out. Each tape sample was folded once on the short side and twice on the long side, and folded to have a size of 6 mm×8 mm. The three tape samples thus folded were stacked and disposed in a vibrating sample magnetometer. The three tape samples were stacked such that the directions of the respective tape samples (the longitudinal direction and the width direction of the tape samples) coincided with each other.

TEM-WF82.5R-152 manufactured by Toei Industry Co., Ltd. was used as a vibrating sample magnetometer, and an external magnetic field was swept at a measurement temperature of 24° C., to obtain a hysteresis curve (M-H curve). The measurement for obtaining the vertical M-H curve was performed by disposing the tape sample in a vibrating sample magnetometer such that the magnetic field application direction and the surface of the tape sample were orthogonal to each other. The external magnetic field was swept according to the sweeping conditions shown in Table 5, with the average number in each step=1, starting from a magnetic field intensity of 1197 kA/m, sweeping to −1197 kA/m, and then sweeping to 1197 kA/m again. The sweeping conditions shown in Table 5 were sequentially carried out in the order from the upper row to the lower row. The total sweeping time was 312 seconds. In addition, the magnetization amount of only a measurement sample probe was measured in advance, and was subtracted as background noise in a case of measurement. For each tape sample, the saturation magnetization obtained from the vertical M-H curve thus obtained was in a range of 5×10⁻⁶ to 10×10⁻⁶ A·m² (5×10⁻³ to 10×10⁻³ emu).

The vertical squareness ratio of each magnetic tape was obtained from the vertical M-H curve obtained by the above measurement.

TABLE 5

| | | Time | | Waiting | |
|---|---|---|---|---|---|
| Upper Limit | Lower limit | constant | | time at | |
| Field | field | (TC) | Step | each step | Time |
| (kA/m) | (kA/m) | (sec.) | (kA/m) | (sec.) | (sec.) |
| 1197 | 0 | 0.1 | 6.2 | 0.1 | 27 |
| 0 | −796 | 0.1 | 0.9 | 0.1 | 120 |
| −796 | −1197 | 0.1 | 6.2 | 0.1 | 9 |
| −1197 | 0 | 0.1 | 6.2 | 0.1 | 27 |
| 0 | 796 | 0.1 | 0.9 | 0.1 | 120 |
| 796 | 1197 | 0.1 | 6.2 | 0.1 | 9 |

### (4) Arithmetic Average Roughness Ra of Surface of Magnetic Layer

A Nanoscope4 manufactured by Veeco Instruments, Inc. was used as an AFM in a tapping mode, and RTESP-300 manufactured by BRUKER was used as a probe. A region of an area of 40 μm×40 μm on the surface of the magnetic layer of each of the magnetic tapes of Examples and Comparative Examples was measured at a scan speed (probe movement speed) at which one screen (512 pixel×512 pixel) was measured in 341 seconds, and the arithmetic average roughness Ra was obtained as described above.

### (5) Total Thickness of Magnetic Tape

Ten tape samples (5 cm in length) were cut out from any part of each magnetic tape of Examples and Comparative Examples, and these tape samples were stacked to measure the thickness. The thickness was measured using a digital thickness gauge of Millimar 1240 compact amplifier and Millimar 1301 induction probe manufactured by MARH Inc. A value (thickness per tape sample) obtained by dividing the measured thickness by 1/10 was defined as the tape total thickness.

### Performance Evaluation Method

### (1) Friction Characteristics

Each magnetic tape of Examples and Comparative Examples was wound around a round bar, which was made of alumina titanium carbide (AlTiC) and had an arithmetic mean roughness Ra of 15 nm and a diameter of 4 mm, as measured in a region having a size of 40 μm×40 μm using the AFM, such that the width direction of the magnetic tape was parallel to the axial direction of the round bar, the magnetic tape was slid by 45 mm per pass at a speed of 14 mm/sec in a state where a weight of 100 g was hung on one end of the magnetic tape at a wrap angle of 20° and the other end was attached to a load cell, and the sliding of a total of 100 passes was repeated. In this case, a load during sliding of the first pass and the 100th pass at a constant velocity was detected by the load cell to obtain a measured value, and friction coefficients of the first pass and the 100th pass were calculated based on Equation: friction coefficient=In (measured value (g)/100 (g))/0.349 (the denominator of Equation is a value obtained by converting the wrap angle of 200 into a radian unit). The measurement environment was an environment of a low temperature and a high humidity, which is considered to have the highest friction coefficient in a guaranteed environment such as a linear tape-open (LTO) drive, specifically an environment of a temperature of 13° C. and a relative humidity of 80%.

Regarding the evaluation result, in a case where the friction coefficient could not be evaluated due to sticking between the magnetic layer surface of the magnetic tape and the round bar during the measurement, the evaluation result was “E”. In addition, since the friction coefficient corresponding to the measurement upper limit value of the load cell is 0.80, it is not possible to measure the friction coefficient exceeding 0.80. In a case where the friction coefficient exceeded the measurement upper limit value of the load cell, the evaluation result was “D”. In a case where the friction coefficient was less than 0.5, the evaluation result was “A”, in a case where the friction coefficient was 0.5 or more and less than 0.6, the evaluation result was “B”, and in a case where the friction coefficient was in a range of 0.6 to 0.8, the evaluation result was “C”. In a case where the evaluation result was A or B, it can be said that the friction characteristics are excellent.

### (2) Degree of Occurrence of Debris

A dummy head made of glass (hereinafter, referred to as a “glass head”) simulating the magnetic head was manufactured. This glass head was attached to a reel-to-reel tester, and a pass was adjusted such that the magnetic tape was brought into contact with a surface of the glass head at a wrap angle of 2°. The magnetic tape was run under conditions of a load of 60 gf applied to the glass head, a running speed of 6 m/sec, and a running length of 1,000 μm. Regarding a unit, “gf” indicates a gram weight, and 1 N (Newton) is about 102 gf.

The presence or absence of an attachment on the magnetic head surface in contact with the magnetic tape and a degree of the attachment were confirmed by observing the glass head from a back surface side of the surface with a digital microscope. The degree of occurrence of debris was evaluated according to the following evaluation standard.

### Evaluation Standard

A: No attachment was found on the surface of the glass head in contact with the magnetic tape.
B: Attachments were partially found on the surface of the glass head in contact with the magnetic tape.
C: Attachments were attached onto the surface of the glass head in contact with the magnetic tape.

The above results are shown in Table 6.

TABLE 6

| | Composition for forming | | | Composition for forming | | Fluorine-based | | |
|---|---|---|---|---|---|---|---|---|
| | magnetic layer | | | non-magnetic layer | | compound | | |
| | Ferro- | | Stearic acid | | Stearic acid | Addition | | |
| | magnetic | Stearic acid | amide | Stearic acid | amide | amount | Addition | ΔC |
| | powder | [parts] | [parts] | [parts] | [parts] | [parts] | method | [at %] |
| Example 1 | BaFe | 1.00 | 0.30 | 1.00 | 0.30 | 1.00 | Magnetic layer | 24.2 |
| | | | | | | | intra-addition | |
| Example 2 | BaFe | 1.00 | 0.30 | 1.50 | 0.30 | 1.50 | Magnetic layer | 22.6 |
| | | | | | | | intra-addition | |
| Example 3 | BaFe | 1.00 | 0.30 | 1.50 | 0.30 | 0.50 | Magnetic layer | 28.0 |
| | | | | | | | intra-addition | |
| Example 4 | BaFe | 1.00 | 0.30 | 0.75 | 0.30 | 1.50 | Magnetic layer | 16.2 |
| | | | | | | | intra-addition | |
| Example 5 | BaFe | 1.00 | 0.30 | 0.75 | 0.30 | 0.50 | Magnetic layer | 19.1 |
| | | | | | | | intra-addition | |
| Example 6 | BaFe | 1.00 | 0.30 | 1.00 | 0.30 | 1.00 | Magnetic layer | 24.9 |
| | | | | | | | intra-addition | |
| Example 7 | BaFe | 1.00 | 0.30 | 1.00 | 0.30 | 1.00 | Magnetic layer | 24.3 |
| | | | | | | | intra-addition | |
| Example 8 | SrFe | 1.00 | 0.30 | 1.50 | 0.30 | 1.50 | Magnetic layer | 22.4 |
| | | | | | | | intra-addition | |
| Example 9 | ε-Iron | 1.00 | 0.30 | 1.50 | 0.30 | 1.50 | Magnetic layer | 21.7 |
| | oxide | | | | | | intra-addition | |
| Comparative | BaFe | 1.00 | 0.30 | 1.00 | 0.30 | None | — | 25.6 |
| Example 1 | | | | | | | | |
| Comparative | BaFe | 1.00 | 0.30 | 1.00 | 0.30 | 0.25 | Magnetic layer | 25.2 |
| Example 2 | | | | | | | intra-addition | |
| Comparative | BaFe | 1.00 | 0.30 | 2.00 | 0.30 | 1.00 | Magnetic layer | 40.1 |
| Example 3 | | | | | | | intra-addition | |
| Comparative | BaFe | 1.00 | 0.30 | 0 | 0 | 1.00 | Magnetic layer | 8.8 |
| Example 4 | | | | | | | intra-addition | |
| Comparative | BaFe | 0 | 0 | 0 | 0 | 1.00 | Magnetic layer | 7.4 |
| Example 5 | | | | | | | intra-addition | |
| Comparative | BeFe | 1.00 | 0.30 | 1.00 | 0.30 | 1.00 | Overcoat | 16.3 |
| Example 6 | | | | | | | | |

| | | Total | | Vertical | Contact | | Degree of |
|---|---|---|---|---|---|---|---|
| | F | Thickness | Ra | squareness | angle | Friction | occurrence |
| | [at %] | [μm] | [mn] | ratio | [°] | characteristic | of debris |
| Example 1 | 2.0 | 4.6 | 1.69 | 0.64 | 98 | B | A |
| Example 2 | 4.5 | 4.6 | 1.73 | 0.64 | 100 | A | A |
| Example 3 | 1.4 | 4.6 | 1.72 | 0.64 | 99 | B | A |
| Example 4 | 2.7 | 4.6 | 1.60 | 0.64 | 100 | A | A |
| Example 5 | 2.3 | 4.6 | 1.52 | 0.64 | 96 | B | A |
| Example 6 | 2.5 | 4.6 | 1.68 | 0.73 | 98 | B | A |
| Example 7 | 2.3 | 4.0 | 1.60 | 0.64 | 98 | B | A |
| Example 8 | 4.6 | 4.6 | 1.60 | 0.63 | 99 | B | A |
| Example 9 | 4.2 | 4.6 | 1.79 | 0.62 | 98 | A | A |
| Comparative | 0.0 | 4.6 | 1.75 | 0.64 | 93 | D | B |
| Example 1 | | | | | | | |
| Comparative | 0.8 | 4.6 | 1.60 | 0.64 | 94 | C | A |
| Example 2 | | | | | | | |
| Comparative | 1.9 | 4.6 | 1.80 | 0.64 | 97 | B | C |
| Example 3 | | | | | | | |
| Comparative | 3.8 | 4.6 | 1.94 | 0.64 | 91 | E | C |
| Example 4 | | | | | | | |
| Comparative | 4.0 | 4.6 | 1.80 | 0.64 | 89 | E | C |
| Example 5 | | | | | | | |
| Comparative | 6.6 | 4.6 | 1.76 | 0.64 | 100 | B | C |
| Example 6 | | | | | | | |

From the results shown in Table 6, it can be confirmed that each of the magnetic tapes of Examples has excellent friction characteristics and generates less debris.

For each of the magnetic tapes of Examples 1 to 9, a value of B was obtained at three randomly selected portions by the following method, and an arithmetic average of the obtained values was used as a value of B of each magnetic tape. The value of B of each magnetic tape thus obtained was in a range of 65% to 85%.

As a pretreatment, a diamond cutting edge was attached to a SAICAS device manufactured by Daipla Wintes Co., Ltd. and used to form an obliquely cut surface by the method described above. A penetration angle of the diamond cutting edge with respect to the surface of the magnetic layer of the magnetic tape was 0.115 degrees.

A TOF-SIMS device manufactured by ULVAC-PHI, Inc. was used as a TOF-SIMS device in a high mass resolution mode, and line profile analysis was performed by the method described above, to obtain Ftotal and Fupper by the method described above. Here, a C₃OF₇₋ fragment was adopted as the fluorine-based fragment. Phenylphosphonic acid was selected as a component of the non-magnetic layer, which is a portion adjacent to the magnetic layer, and a PO₃_{^{−}} fragment, which is a fragment confirmed to detect this component with the highest sensitivity as a result of preliminary experiment, was adopted as a fragment of this component.

B was calculated by Equation 1 from the Ftotal and the Fupper thus obtained.

$$B = ( Fupper / Ftotal ) \times 100 \qquad Equation 1$$

The present invention is useful in the technical field of various magnetic recording media such as a magnetic tape for data storage.

What is claimed is:

1. A magnetic recording medium comprising:
a non-magnetic support; and
a magnetic layer containing a ferromagnetic powder,
wherein a contact angle with water, which is measured on a surface of the magnetic layer, is 96 degrees or more,
a fluorine concentration F obtained by X-ray photoelectron spectroscopy performed on the surface of the magnetic layer at a photoelectron take-off angle of 10 degrees is 1.0 at % or more and less than 5.0 at %, and ΔC calculated by Equation ΔC=C_{before}− C_{after} is 10.0 at % or more and 30.0 at % or less,
the C_{before} is a C—H derived carbon concentration calculated from a C—H peak surface area ratio in C1s spectra obtained by the X-ray photoelectron spectroscopy performed on the surface of the magnetic layer at the photoelectron take-off angle of 10 degrees before a methanol extraction treatment, and
the C_{after} is a C—H derived carbon concentration calculated from the C—H peak surface area ratio in the C1s spectra obtained by the X-ray photoelectron spectroscopy performed on the surface of the magnetic layer at the photoelectron take-off angle of 10 degrees after the methanol extraction treatment.

2. The magnetic recording medium according to claim 1,
wherein the contact angle is 96 degrees or more and 110 degrees or less.

3. The magnetic recording medium according to claim 1,
wherein a vertical squareness ratio of the magnetic recording medium is 0.60 or more.

4. The magnetic recording medium according to claim 1,
wherein a vertical squareness ratio of the magnetic recording medium is 0.65 or more.

5. The magnetic recording medium according to claim 1, further comprising:
a non-magnetic layer containing a non-magnetic powder between the non-magnetic support and the magnetic layer.

6. The magnetic recording medium according to claim 1, further comprising:
a back coating layer containing a non-magnetic powder on a surface side of the non-magnetic support opposite to a surface side having the magnetic layer.

7. The magnetic recording medium according to claim 1,
wherein a total thickness of the magnetic recording medium is 5.2 μm or less.

8. The magnetic recording medium according to claim 1,
wherein a total thickness of the magnetic recording medium is 5.0 μm or less.

9. The magnetic recording medium according to claim 1,
wherein the non-magnetic support is a polyamide support.

10. The magnetic recording medium according to claim 1,
wherein the ferromagnetic powder is a hexagonal ferrite powder.

11. The magnetic recording medium according to claim 10,
wherein the hexagonal ferrite powder is a hexagonal barium ferrite powder.

12. The magnetic recording medium according to claim 10,
wherein the hexagonal ferrite powder is a hexagonal strontium ferrite powder.

13. The magnetic recording medium according to claim 1,
wherein the ferromagnetic powder is an ε-iron oxide powder.

14. The magnetic recording medium according to claim 1,
wherein the magnetic recording medium is a magnetic tape.

15. The magnetic recording medium according to claim 1,
wherein the contact angle is 96 degrees or more and 110 degrees or less,
a vertical squareness ratio of the magnetic recording medium is 0.65 or more,
a non-magnetic layer containing a non-magnetic powder is further provided between the non-magnetic support and the magnetic layer,
a back coating layer containing a non-magnetic powder is further provided on a surface side of the non-magnetic support opposite to a surface side having the magnetic layer,
a total thickness of the magnetic recording medium is 5.0 μm or less,
the non-magnetic support is a polyamide support,
the ferromagnetic powder is selected from the group consisting of a hexagonal barium ferrite powder, a hexagonal strontium ferrite powder, and an ε-iron oxide powder, and
the magnetic recording medium is a magnetic tape.

16. A magnetic tape cartridge comprising:
the magnetic tape according to claim 14.

17. A magnetic tape cartridge comprising:
the magnetic tape according to claim 15.

18. A magnetic recording and reproducing device comprising:
the magnetic recording medium according to claim 1.
